(19) United States
(12) Patent Application Publication
(10) Pub. No.: US 2010/0234227 A1
(43) Pub. Date: Sep. 16, 2010

(54) MICROEMULSION CONCENTRATES

(76) Inventors: Thomas Maier, Hofheim (DE); Detlev Haase, Frankfurt (DE); Gerhard Schnabel, Elsenfeld (DE); Gerhard Frisch, Wehrheim (DE); Dorel-Gheorghe Merk, Oberursel (DE); Gerd Schweinitzer, Frankfurt (DE); Ralph Grohs, Dusseldorf (DE)

Correspondence Address: FROMMER LAWRENCE & HAUG, 745 FIFTH AVENUE- 10TH FL., NEW YORK, NY, 10151, US

(21) Appl. No.: 12/376,490

(22) PCT Filed: Jul. 23, 2007
(86) PCT No.: PCT/EP2007/006522

§ 371 Date: May 21, 2010

(30) Foreign Application Priority Data
Aug. 5, 2006 (EP) 06016397.9

(51) Int. Cl. A01N 43/36; A01N 43/76; A01P 13/00

(52) U.S. Cl. 504/138; 504/270

(57) ABSTRACT

The present invention relates to a microemulsion concentrate, comprising
(a) one or more agrochemical active substances, in particular from the group consisting of the fungicides, insecticides, plant growth regulators, herbicides and safeners,
(b) one or more alcoholic solvents with at least 5 carbon atoms,
(c) one or more nonalcoholic solvents,
(d) one or more anionic surfactants, and
(e) one or more nonionic surfactants.

The microemulsion concentrate is suitable in the field of plant protection.

The present invention relates to the field of formulations comprising plant protection agents. The invention relates in particular to liquid agrochemical formulations in the form of microemulsion concentrates and microemulsions.

Active substances for plant protection are generally not used in their pure form. Depending on the field of application and the type of application, and on physical, chemical and biological parameters, the active substance is used in a mixture with conventional auxiliaries and additives as solid or liquid active substance formulation. However, the active substance formulation of combinations (mixtures) with additional active substances for broadening the spectrum of activities and/or for protecting crop plants, such as with safeners (antidotes), is also an important field of activity of formulation technology since active substances with in some cases quite different physical, chemical and biological parameters have to be suitably formulated together here.

Formulations of combinations of several active substances for plant protection should thus generally exhibit high chemical and physical stability, good applicability and user friendliness, and a broad biological action with high selectivity with regard to the active substances used, in addition to a satisfactory ability to be formulated industrially in the manufacturing process.

Liquid formulations are, e.g., described in EP 0 261 492, EP 0 394 847, WO 95/17822, WO 98/31223, WO 89/03176, EP 0 357 149, WO 02/45507, GB 2 267 825 A, WO 94/23578, EP 0 330 904, EP 0 533 057, EP 0 533 057, DE 36 24 910, WO 01/74785, EP 0 400 585, EP 0 118 579, XP 002 177 928, EP 0 648 414 A1, U.S. Pat. No. 5,300,529, U.S. Pat. No. 0,533,057, EP 0 330 904 A1, DE 2 328 192 A1, EP 0 432 062 A1, EP 0 297 207 A1, DE 81 162 B1, EP 0 244 754 A1, WO 99/45780, WO 99/40784, WO 87/04047, DE 3 618 535 A1, WO 04/054360 and WO 98/16102. EP 0 257 286 A1 describes the preparation of a microemulsion (ME) for the insecticide endosulfan which uses a solvent mixture in which isobutanol, a C₄-alcohol, is present.

It is an object of the present invention to make available an improved formulation comprising plant protection agents which is also advantageous with regard to the active substances and/or combinations thereof used, such as, e.g., exhibiting improved activity.

It has now been found, surprisingly, that this object is achieved by the special microemulsion concentrate (MC) of the present invention.

The present invention accordingly relates to a microemulsion concentrate, comprising
(a) one or more agrochemical active substances, in particular from the group consisting of the fungicides, insecticides, plant growth regulators, herbicides and safeners,
(b) one or more alcoholic solvents with at least 5 carbon atoms,
(c) one or more nonalcoholic solvents,
(d) one or more anionic surfactants, and
(e) one or more nonionic surfactants.

In addition, the microemulsion concentrate according to the invention can, if appropriate, yet comprise, as additional components, (f) conventional auxiliaries and additives.

The term “microemulsion concentrate (MC)” is understood to mean a composition which, on diluting with water, forms microemulsions (ME), e.g. oil-in-water microemulsions or water-in-oil microemulsions. The term “a microemulsion” is understood to mean an emulsion which is thermodynamically stable and which exhibits a small droplet size of the emulsified phase generally lying in the range of 10-400 nm, preferably 20-350 nm.

Accordingly, microemulsion concentrates are characterized, inter alia, in that no water is used as formulation auxiliary. Nevertheless, contamination by water can infiltrate via the individual components. This water content, up to a maximum ≦2% by weight, generally 0 to ≦1% by weight, is however insignificant for the quality of the microemulsion concentrate.

The microemulsion concentrates according to the invention generally comprise the following amounts of components (a), (b), (c), (d), (e) and (f); in this connection the specification “% by weight”, here and throughout the description, unless otherwise defined, refers to the relative weight of the respective component, based on the total weight of the formulation:

component (a): 0.001-50% by weight, preferably 0.1-45% by weight, particularly preferably 1-40% by weight.
component (b): 1-60% by weight, preferably 2-50% by weight, particularly preferably 3-40% by weight.
component (c): 5-90% by weight, preferably 8-85% by weight, particularly preferably 12-70% by weight.
component (d): 0.1-30% by weight, preferably 0.5-25% by weight, particularly preferably 1-40% by weight.
component (e): 0.1-70% by weight, preferably 1-60% by weight, particularly preferably 2-50% by weight.
component (f): 0-40% by weight, preferably 0-35% by weight, particularly preferably 0-30% by weight.

All active substances which can be used in the agrochemical field are suitable as active substances (component a) in the microemulsion concentrate according to the invention. Mention may preferably be made of fungicides, bactericides, insecticides, acaricides, nematicides, molluscicides, rodenticides, repellents, plant growth regulators, herbicides and safeners, and also plant nutrients. Subsequently, the term “fungicides” encompasses both fungicides as well as bactericides and viricides, the term “insecticides” encompasses both insecticides as well as acaricides, nematicides, molluscicides, rodenticides and repellents, and the term “herbicides” encompasses both herbicides as well as plant growth regulators, insofar as this does not otherwise emerge from the context.

The agrochemical active substances can be fungicides, for example

inhibitors of nucleic acid synthesis, in particular
benalaxyl, benalaxyl-M, bupirimate, chiralaxyl, clozylacon, dimethirimol, ethirimol, furalaxyl, hymexazol, metalaxyl, metalaxyl-M, ofurace, oxadixyl, oxolinic acid;
   inhibitors of mitosis and cell division, in particular
benomyl, carbendazim, diethofencarb, fuberidazole, pencycuron, thiabendazole, thiophanate-methyl, zoxamide;
   inhibitors of the respiratory chain complex I, in particular
diflumetorim;
   inhibitors of the respiratory chain complex II, in particular
boscalid, carboxin, fenfuram, flutolanil, furametpyr, mepronil, oxycarboxin, penthiopyrad, thifluzamide;
   inhibitors of the respiratory chain complex III, in particular
azoxystrobin, cyazofamid, dimoxystrobin, enestrobin, famoxadone, fenamidone, fluoxastrobin, cresoxim-methyl, metominostrobin, orysastrobin, pyraclostrobin, picoxystrobin, trifloxystrobin;
   uncouplers, in particular
dinocap, fluazinam;
   inhibitors of ATP production, in particular
fentin acetate, fentin chloride, fentin hydroxide, silthiofam;
   inhibitors of amino acid and protein biosynthesis, in particular
andoprim, blasticidin-S, cyprodinil, kasugamycin, kasugamycin hydrochloride hydrate, mepanipyrim, pyrimethanil;
   inhibitors of signal transduction, in particular
fenpiclonil, fludioxonil, quinoxyfen;
   inhibitors of lipid and membrane synthesis, in particular
chlozolinate, iprodione, procymidone, vinclozolin,
ampropylfos, ampropylfos potassium, edifenphos, iprobenfos (IBP),
isoprothiolane, pyrazophos,
tolclofos-methyl, biphenyl,
iodocarb, propamocarb, propamocarb hydrochloride;
   inhibitors of ergosterol biosynthesis, in particular
fenhexamide,
azaconazole, bitertanol, bromuconazole, cyproconazole, diclobutrazol, difenoconazole, diniconazole, diniconazole-M, epoxiconazole, etaconazole, fenbuconazole, fluquinconazole, flusilazole, flutriafol, furconazole, furconazole-cis, hexaconazole, imibenconazole, ipconazole, metconazole, myclobutanil, paclobutrazol, penconazole, propiconazole, prothioconazole, simeconazole, tebuconazole, tetraconazole, triadimefon, triadimenol, triticonazole, uniconazole, voriconazole, imazalil, imazalil sulfate, oxpoconazole, fenarimol, flurprimidol, nuarimol, pyrifenox, triforine, pefurazoate, prochloraz, triflumizole, viniconazole, aldimorph, dodemorph, dodemorph acetate, fenpropimorph, tridemorph, fenpropidin, spiroxamine,
naftifine, pyributicarb, terbinafine;
   inhibitors of cell wall synthesis, in particular
benthiavalicarb, bialaphos, dimethomorph, flumorph, iprovalicarb, polyoxins, polyoxorim, validamycin A;
   inhibitors of melanin biosynthesis, in particular
carpropamid, diclocymet, fenoxanil, phthalide, pyroquilon, tricyclazole;
   resistance inducers, in particular
acibenzolar-S-methyl, probenazole, tiadinil;
   multisite, in particular
captafol, captan, chlorothalonil, copper salts, such as: copper hydroxide, copper naphthenate, copper oxychloride, copper sulfate, copper oxide, oxine-copper and Bordeaux mixture, dichlofluanid, dithianon, dodine, dodine free base, ferbam, folpet, fluorfolpet, guazatine, guazatine acetate, iminoctadine, iminoctadine albesilate, iminoctadine triacetate, mancopper, mancozeb, maneb, metiram, metiram zinc, propineb, sulfur and sulfur preparations comprising calcium polysulfide, thiram, tolylfluanid, zineb, ziram;
   fungicides with unknown mechanism, in particular
amibromdol, benthiazol, bethoxazin, capsimycin, carvone, chinomethionat, chloropicrin, cufraneb, cyflufenamid, cymoxanil, dazomet, debacarb, diclomezine, dichlorophen, dicloran, difenzoquat, difenzoquat metilsulfate, diphenylamine, ethaboxam, ferimzone, flumetover, flusulfamide, fluopicolide, fluoroimide, hexachlorobenzene, 8-hydroxyquinoline sulfate, irumamycin, methasulfocarb, metrafenone, methyl isothiocyanate, mildiomycin, natamycin, nickel dimethyldithiocarbamate, nitrothal-isopropyl, octhilinone, oxamocarb, oxyfenthiin, pentachlorophenol and salts, 2-phenylphenol and salts, piperalin, propanosine-sodium, proquinazid, pyrrolnitrin, quintozene, tecloftalam, tecnazene, triazoxide, trichlamide, zarilamid and 2,3,5,6-tetrachloro-4-(methylsulfonyl)pyridine, N-(4-chloro-2-nitrophenyl)-N-ethyl-4-methylbenzene-sulfonamide, 2-amino-4-methyl-N-phenyl-5-thiazolecarboxamide, 2-chloro-N-(2,3-dihydro-1,1,3-trimethyl-1H-inden-4-yl)-3-pyridinecarboxamide, 3-[5-(4-chlorophenyl)-2,3-dimethylisoxazolidin-3-yl]pyridine, cis-1-(4-chlorophenyl)-2-(1H-1,2,4-triazol-1-yl)cycloheptanol, 2,4-dihydro-5-methoxy-2-methyl-4-[[[[[143-(trifluoromethyl)phenyl]ethylidene]amino]oxy]methyl]phenyl]-3H-1,2,3-triazol-3-one (185336-79-2), methyl 1-(2,3-dihydro-2,2-dimethyl-1H-inden-1-yl)-1H-imidazole-5-carboxylate, 3,4,5-trichloro-2,6-pyridinedicarbonitrile, methyl 2-[[[cyclopropyl[(4-methoxyphenyl)imino]methyl]thio]methyl]-α-(methoxy-methylene)benzeneacetate, 4-chloro-α-propynyloxy-N-2-[3-methoxy-4-(2-propynyloxy)phenyl]ethyl]benzeneacetamide, (2S)—N-[2-[4-[[3-(4-chlorophenyl)-2-propynyl]oxy]-3-methoxyphenyl]ethyl]-3-methyl-2-[(methylsulfonyl)amino]-butanamide, 5-chloro-7-(4-methylpiperidin-1-yl)-6-(2,4,6-trifluoro-phenyl)[1,2,4]triazolo[1,5-a]pyrimidine, 5-chloro-6-(2,4,6-trifluorophenyl)-N-[(1R)-1,2,2-trimethylpropyl][1,2,4]triazolo[1,5-a]pyrimidine-7-amine, 5-chloro-N-[(1R)-1,2-dimethylpropyl]-6-(2,4,6-trifluorophenyl)[1,2,4]triazolo[1,5-a]pyrimidine-7-amine, N-[1-(5-bromo-3-chloropyridin-2-yl)ethyl]-2,4-dichloronicotinamide, N-(5-bromo-3-chloropyridin-2-yl)methyl-2,4-dichloronicotinamide, 2-butoxy-6-iodo-3-propylbenzopyran-4-one, N-{(Z)-[(cyclopropylmethoxy)imino][6-(difluoromethoxy)-2,3-difluorophenyl]methyl}-2-benzeneacetamide, N-(3-ethyl-3,5,5-trimethylcyclohexyl)-3-formylamino-2-hydroxybenzamide, 2-[[[[1-[3(1-fluoro-2-phenylethyl)oxy]phenyl]ethylidene]amino]oxy]methyl]-α-(methoxyimino)-N-methyl-αE-benzeneacetamide, N-{2-[3-chloro-5-(trifluoromethyl)pyridin-2-yl]ethyl}-2-(trifluoromethyl)benzeneamide, N-(3′,4′-dichloro-5-fluorobiphenyl-2-yl)-3-(difluoromethyl)-1-methyl-1H-pyrazole-4-carboxamide, N-(6-methoxy-3-pyridinyl)cyclopropanecarboxamide, 1-[(4-methoxyphenoxy)methyl]-2,2-dimethylpropyl-1H-imidazole-1-carboxylic acid, O-[1-[(4-methoxyphenoxy)-methyl]-2,2-dimethylpropyl]-1H-imidazole-1-carbothioic acid, 2-(2-{[6-(3-chloro-2-methylphenoxy)-5-fluoropyrimidin-4-yl]oxy}phenyl)-2-(methoxyimino)-N-methylacetamide.

The agrochemical active substances can also be bactericides, for example bronopol, dichlorophen, nitrapyrin, nickel dimethyldithiocarbamate, kasugamycin, 1.5 octhilinone, furancarboxylic acid, oxytetracycline, probenazole, streptomycin, tecloftalam, copper sulfate and other copper compositions.

The fungicides (bactericides) listed above are, e.g., known from “The Pesticide Manual”, 12^{th} edition (2000) and 13^{th} edition (2003), The British Crop Protection Council, or the literature references listed after the individual active substances.

The agrochemical active substances can also be insecticides/acaricides and/or nematicides, for example

acetylcholinesterase (AChE) inhibitors
carbamates,
for example alanycarb, aldicarb, aldoxycarb, allyxycarb, aminocarb, bendiocarb, benfuracarb, bufencarb, butacarb, butocarboxim, butoxycarboxim, carbaryl, carbofuran, carbosulfan, cloethocarb, dimetilan, ethiofencarb, fenobucarb, fenothiocarb, formetanate, furathiocarb, isoprocarb, metam-sodium, methiocarb, methomyl, metolcarb, oxamyl, pirimicarb, promecarb, propoxur, thiodicarb, thiofanox, trimethacarb, XMC, xylylcarb, triazamate;
organophosphates,
for example acephate, azamethiphos, azinphos (-methyl, -ethyl), bromo-phosethyl, bromfenvinfos (-methyl), butathiofos, cadusafos, carbophenothion, chlorethoxyfos, chlorfenvinphos, chlormephos, chlorpyrifos (-methyl/-ethyl), coumaphos, cyanofenphos, cyanophos, chlorfenvinphos, demeton-S-methyl, demeton-S-methylsulphon, dialifos, diazinon, dichlofenthion, dichlorvos/DDVP, dicrotophos, dimethoate, dimethylvinphos, dioxabenzofos, disulfoton, EPN, ethion, ethoprophos, etrimfos, famphur, fenamiphos, fenitrothion, fensulfothion, fenthion, flupyrazofos, fonofos, formothion, fosmethilan, fosthiazate, heptenophos, iodofenphos, iprobenfos, isazofos, isofenphos, isopropyl O-salicylate; isoxathion, malathion, mecarbam, methacrifos, methamidophos, methidathion, mevinphos, monocrotophos, naled, omethoate, oxydemeton-methyl, parathion (-methyl/-ethyl), phenthoate, phorate, phosalone, phosmet, phosphamidon, phosphocarb, phoxim, pirimiphos (-methyl/-ethyl), profenofos, propaphos, propetamphos, prothiofos, prothoate, pyraclofos, pyridaphenthion, pyridathion, quinalphos, sebufos, sulfotep, sulprofos, tebupirimfos, temephos, terbufos, tetrachlorvinphos, thiometon, triazophos, trichlorfon, vamidothion;
   sodium channel modulators/voltage-dependent sodium channel blockers
pyrethroides,
for example acrinathrin, allethrin (d-cis-trans, d-trans), beta-cyfluthrin, bifenthrin, bioallethrin, bioallethrin-S-cyclopentenyl isomer, bioethanomethrin, biopermethrin, bioresmethrin, chlovaporthrin, cis-cypermethrin, cis-resmethrin, cis-permethrin, clocythrin, cycloprothrin, cyfluthrin, cyhalothrin, cypermethrin (alpha-, beta-, theta-, zeta-), cyphenothrin, deltamethrin, empenthrin (1R-isomer), esfenvalerate, etofenprox, fenfluthrin, fenpropathrin, fenpyrithrin, fenvalerate, flubrocythrinate, flucythrinate, flufenprox, flumethrin, fluvalinate, fubfenprox, gamma-cyhalothrin, imiprothrin, kadethrin, lambda-cyhalothrin, metofluthrin, permethrin (cis-, trans-), phenothrin (1R-trans-isomer), prallethrin, profluthrin, protrifenbute, pyresmethrin, resmethrin, RU 15525, silafluofen, tau-fluvalinate, tefluthrin, terallethrin, tetramethrin (1R-isomer), tralomethrin, transfluthrin, ZXI 8901, pyrethrins (pyrethrum);
DDT;
oxadiazines,
for example indoxacarb;
semicarbazones,
for example metaflumizone (BAS3201);
   acetylcholine receptor agonists/antagonists
chloronicotinyls,
for example acetamiprid, clothianidin, dinotefuran, imidacloprid, nitenpyram, nithiazine, thiacloprid, thiamethoxam
nicotine, bensultap, cartap;
   acetylcholine receptor modulators
spinosyns,
for example spinosad;
   GABA-controlled chloride channel antagonists
organochlorines,
for example camphechlor, chlordane, endosulfan, gamma-HCH, HCH, heptachlor, lindane, methoxychlor;
fiproles,
for example acetoprole, ethiprole, fipronil, pyrafluprole, pyriprole, vaniliprole;
   chloride channel activators
mectins,
for example abamectin, emamectin, emamectin benzoate, ivermectin, lepimectin, milbemycin;
   juvenile hormone mimics,
for example diofenolan, epofenonane, fenoxycarb, hydroprene, kinoprene, methoprene, pyriproxyfen, triprene;
   Ecdysone agonists/disruptors
diacylhydrazines,
for example chromafenozide, halofenozide, methoxyfenozide, tebufenozide;
   inhibitors of chitin biosynthesis
benzoylureas,
for example bistrifluoron, chlofluazuron, diflubenzuron, fluazuron, flucycloxuron, flufenoxuron, hexaflumuron, lufenuron, novaluron, noviflumuron, penfluoron, teflubenzuron, triflumuron;
buprofezin;
cyromazine;
   inhibitors of oxidative phosphorylation, ATP disruptors
diafenthiuron,
organotin compounds,
for example azocyclotin, cyhexatin, fenbutatin oxide;
   uncouplers of oxidative phoshorylation by interruption of the H-proton gradient
pyrroles,
for example chlorfenapyr;
dinitrophenols,
for example binapacyrl, dinobuton, dinocap, DNOC;
   Site-I electron transport inhibitors
METIs,
for example fenazaquin, fenpyroximate, pyrimidifen, pyridaben, tebufenpyrad,
tolfenpyrad,
hydramethylnon,
dicofol;
   Site-II electron transport inhibitors
rotenone;
   Site-III electron transport inhibitors
acequinocyl, fluacrypyrim;
   microbial disruptors of the insect gut membrane
Bacillus thuringiensis strains;
   inhibitors of lipid synthesis
tetronic acids,
for example spirodiclofen, spiromesifen
tetramic acids,
for example spirotetramat
carboxamides,
for example flonicamid
octopaminergic agonists,
for example amitraz;
   inhibitors of magnesium-stimulated ATPase,
propargite
nereistoxin analogs,
for example thiocyclam hydrogen oxalate or thiosultap-sodium;
   agonists of the ryanodine receptor,
benzoic acid dicarboxamides,
for example flubendiamide
anthranilamides,
for example DPX E2Y45 (3-bromo-N-{4-chloro-2-methyl-6-[(methylamino)carbonyl]phenyl}-1-(3-chloropyridin-2-yl)-1H-pyrazole-5-carboxamide);
   biologicals, hormones or pheromones
azadirachtin, Bacillus spec., Beauveria spec., codlemone, Metarrhizium spec., Paecilomyces spec., thuringiensin, Verticillium spec.;
   active substances with unknown or nonspecific mechanisms of action
antifeedants,
for example cryolite, flonicamid, pymetrozine;
mite growth inhibitors,
for example clofentezine, etoxazole, hexythiazox;
amidoflumet, benclothiaz, benzoximate, bifenazate, bromopropylate, buprofezin, chinomethionat, chlordimeform, chlorobenzilate, chloropicrin, clothiazoben, cycloprene, cyflumetofen, dicyclanil, fenoxacrim, fentrifanil, flubenzimine, flufenerim, flutenzine, gossyplure, hydramethylnon, japonilure, metoxadiazone, petroleum, piperonyl butoxide, potassium oleate, pyridalyl, sulfluramid, tetradifon, tetrasul, triarathene, verbutin.

The insecticides (acaricides, nematicides) listed above are, e.g., known from “The Pesticide Manual”, 12^{th} edition (2000) and 13^{th} edition (2003), The British Crop Protection Council, or the literature references listed after the individual active substances.

The agrochemical active substances can also be herbicides and/or plant growth regulators; for example ALS inhibitors (acetolactate synthase inhibitors) or herbicides other than ALS inhibitors, such as herbicides from the group consisting of the carbamates, thiocarbamates, haloacetanilides, substituted phenoxy-, naphthoxy- and phenoxyphenoxycarboxylic acid derivatives, and also heteroaryloxyphenoxyalkane-carboxylic acid derivatives, such as quinolyloxy-, quinoxalyloxy-, pyridyloxy-, benzoxazolyloxy- and benzthiazolyloxyphenoxyalkanecarboxylic acid esters, cyclohexanedione derivatives, phosphorus-comprising herbicides, e.g. of the glufosinate type or of the glyphosate type, S—(N-aryl-N-alkylcarbamoylmethyl)dithiophosphoric acid esters, ureas, and also hydroxybenzonitriles.

The ALS inhibitors are in particular imidazolinones, pyrimidinyloxypyridinecarboxylic acid derivatives, pyrimidyloxybenzoic acid derivatives, triazolopyrimidinesulfonamide derivatives and sulfonamides, preferably from the group consisting of the sulfonylureas.

The active substances from the group consisting of the ALS inhibitors, such as sulfonylureas, present as component in the microemulsion concentrates according to the invention are, within the meaning of the present invention, in addition to the neutral compounds, always also to be understood as the salts thereof with inorganic and/or organic counterions. Thus, e.g., sulfonylureas can form, e.g., salts in which the hydrogen of the —SO₂—NH— group is replaced by an agriculturally suitable cation. These salts are, for example, metal salts, in particular alkali metal salts or alkaline earth metal salts, in particular sodium and potassium salts, or also ammonium salts or salts with organic amines. Likewise, salt formation can occur by addition of an acid to basic groups, such as, e.g., amino and alkylamino. Suitable acids for this are strong inorganic and organic acids, for example HCl, HBr, H₂SO₄ or HNO₃.

Preferred ALS inhibitors come from the group of the sulfonylureas, e.g. pyrimidin- or triazinylaminocarbonyl[benzene-, pyridine-, pyrazole-, thiophene- and (alkylsulfonyl)alkylamino]sulfamides. Alkoxy, alkyl, haloalkoxy, haloalkyl, halogen or dimethylamino are preferred as substituents on the pyrimidine ring or triazine ring, all substituents being able to be combined independently of one another. Preferred substituents in the benzene, pyridine, pyrazole, thiophene or (alkylsulfonyl)alkyl-amino part are alkyl, alkoxy, halogen, such as F, Cl, Br or I, amino, alkylamino, dialkylamino, acylamino, such as formylamino, nitro, alkoxycarbonyl, aminocarbonyl, alkylaminocarbonyl, dialkylaminocarbonyl, alkoxyaminocarbonyl, haloalkoxy, haloalkyl, alkylcarbonyl, alkoxyalkyl, alkylsulfonylaminoalkyl, (alkanesulfonyl)alkylamino. Such suitable sulfonylureas are, for example,

A1) phenyl- and benzylsulfonylureas and related compounds, e.g.
1-(2-chlorophenylsulfonyl)-3-(4-methoxy-6-methyl-1,3,5-triazin-2-yl)urea (chlorsulfuron),
1-(2-ethoxycarbonylphenylsulfonyl)-3-(4-chloro-6-methoxypyrimidin-2-yl)urea (chlorimuron-ethyl),
1-(2-methoxyphenylsulfonyl)-3-(4-methoxy-6-methyl-1,3,5-triazin-2-yl)urea (metsulfuron-methyl),
1-(2-chloroethoxyphenylsulfonyl)-3-(4-methoxy-6-methyl-1,3,5-triazin-2-yl)urea (triasulfuron),
1-(2-methoxycarbonylphenylsulfonyl)-3-(4,6-dimethylpyrimidin-2-yl)urea (sulfometuron-methyl),
1-(2-methoxycarbonylphenylsulfonyl)-3-(4-methoxy-6-methyl-1,3,5-triazin-2-yl)-3-methylurea (tribenuron-methyl),
1-(2-methoxycarbonylbenzylsulfonyl)-3-(4,6-dimethoxypyrimidin-2-yl)urea (bensulfuron-methyl),
1-(2-methoxycarbonylphenylsulfonyl)-3-(4,6-bis(difluoromethoxy)pyrimidin-2-yl)urea (primisulfuron-methyl),
3-(4-ethyl-6-methoxy-1,3,5-triazin-2-yl)-1-(2,3-dihydro-1,1-dioxo-2-methylbenzo-[b]thiophene-7-sulfonyl)urea (EP-A 0 796 83),
3-(4-ethoxy-6-ethyl-1,3,5-triazin-2-yl)-1-(2,3-dihydro-1,1-dioxo-2-methylbenzo[b]-thiophene-7-sulfonyl)urea (EP-A 0 079 683),
3-(4-methoxy-6-methyl-1,3,5-triazin-2-yl)-1-(2-methoxycarbonyl-5-iodophenyl-sulfonyl)urea (iodosulfuron-methyl and the salts thereof, such as the sodium salt, WO 92/13845),
DPX-66037, triflusulfuron-methyl (see Brighton Crop Prot. Conf.—Weeds—1995, p. 853),
CGA-277476, (see Brighton Crop Prot. Conf.—Weeds—1995, p. 79),
methyl 2-[3-(4,6-dimethoxypyrimidin-2-yl)ureidosulfonyl]-4-(methanesulfonamido-methyl)benzoate (mesosulfuron-methyl and the salts thereof, such as the sodium salt, WO 95/10507),
N,N-dimethyl-2-[3-(4,6-dimethoxypyrimidin-2-yl)ureidosulfonyl]-4-(formylamino)-benzamide (foramsulfuron and the salts thereof, such as the sodium salt, WO 95/01344);
   A2) thienylsulfonylureas, e.g.
1-(2-methoxycarbonylthiophen-3-sulfonyl)-3-(4-methoxy-6-methyl-1,3,5-triazin-2-yl)urea (thifensulfuron-methyl);
   A3) pyrazolylsulfonylureas, e.g.
1-(4-ethoxycarbonyl-1-methylpyrazol-5-ylsulfonyl)-3-(4,6-dimethoxypyrimidin-2-yl)urea (pyrazosulfuron-methyl);
methyl 3-chloro-5-(4,6-dimethoxypyrimidin-2-ylcarbamoylsulfamoyl)-1-methylpyrazole-4-carboxylate (EP-A 0 282 613);
methyl 5-(4,6-dimethylpyrimidin-2-ylcarbamoylsulfamoyl)-1-(2-pyridyl)pyrazole-4-carboxylate (NC-330, see Brighton Crop Prot. Conference Weeds' 1991, Vol. 1, pp. 45 ff.),
DPX-A8947, azimsulfuron, (see Brighton Crop Prot. Conf. ‘Weeds’ 1995, p. 65);
   A4) sulfonediamide derivatives, e.g.
3-(4,6-dimethoxypyrimidin-2-yl)-1-(N-methyl-N-methylsulfonylaminosulfonyl)urea (amidosulfuron) and the structural analogs thereof (EP-A 0 131 258 and Z. Pfl. Krankh. Pfl. Schutz, Sonderheft XII, 489-497 (1990));
   A5) pyridylsulfonylureas, e.g.
1-(3-N,N-dimethylaminocarbonylpyridin-2-ylsulfonyl)-3-(4,6-dimethoxypyrimidin-2-yl)urea (nicosulfuron),
1-(3-ethylsulfonylpyridin-2-ylsulfonyl]-3-(4,6-dimethoxypyrimidin-2-yl)urea (rimsulfuron),
methyl 2-[3-(4,6-dimethoxypyrimidin-2-ylureidosulfonyl]-6-trifluoromethyl-3-pyridine-carboxylate, sodium salt (DPX-KE 459, flupyrsulfuron, see Brighton Crop Prot. Conf. Weeds, 1995, p. 49), trifloxysulfuron and the sodium salt thereof;
   A6) alkoxyphenoxysulfonylureas, such as are described, e.g., in EP-A 0 342 569, preferably 3-(4,6-dimethoxypyrimidin-2-yl)-1-(2-ethoxyphenoxysulfonyl)urea (ethoxysulfuron) or the salts thereof, such as the sodium salt;
   A7) imidazolylsulfonylureas, e.g.
   MON 37500, sulfosulfuron (see Brighton Crop Prot. Conf. ‘Weeds’, 1995, p. 57), and other related sulfonylurea derivatives, and mixtures thereof.

Typical representatives of these active substances are, inter alia, the compounds listed below and the salts thereof, such as the sodium salts: amidosulfuron, azimsulfuron, bensulfuron-methyl, chlorimuron-ethyl, chlorsulfuron, cinosulfuron, cyclosulfamuron, ethametsulfuron-methyl, ethoxysulfuron, flazasulfuron, flupyrsulfuron-methyl-sodium, halosulfuron-methyl, imazosulfuron, metsulfuron-methyl, nicosulfuron, oxasulfuron, primisulfuron-methyl, prosulfuron, pyrazosulfuron-ethyl, rimsulfuron, sulfometuron-methyl, sulfosulfuron, thifensulfuron-methyl, triasulfuron, tribenuron-methyl, trifloxysulfuron and the sodium salt thereof, triflusulfuron-methyl, iodosulfuron-methyl and the sodium salt thereof (WO 92/13845), mesosulfuron-methyl and the sodium salt thereof (Agrow No. 347, 3^{rd} March 2000, page 22 (PJB Publications Ltd. 2000)) and foramsulfuron and the sodium salt thereof (Agrow No. 338, 15^{th} October 1999, page 26 (PJB Publications Ltd. 1999)).

Additional suitable ALS inhibitors are, e.g.

B) imidazolinones, e.g.
methyl 2-(4-isopropyl-4-methyl-5-oxo-2-imidazolin-2-yl)-5-methylbenzoate and 2-(4-isopropyl-4-methyl-5-oxo-2-imidazolin-2-yl)-4-methylbenzoic acid (imazamethabenz), 5-ethyl-2-(4-isopropyl-4-methyl-5-oxo-2-imidazolin-2-yl)pyridine-3-carboxylate (imazethapyr),
2-(4-isopropyl-4-methyl-5-oxo-2-imidazolin-2-yl)quinoline-3-carboxylic acid (imazaquin),
2-(4-isopropyl-4-methyl-5-oxo-2-imidazolin-2-yl)pyridine-3-carboxylic acid (imazapyr),
5-methyl-2-(4-isopropyl-4-methyl-5-oxo-2-imidazolin-2-yl)pyridine-3-carboxylic acid (imazethamethapyr);
   C) triazolopyrimidinesulfonamide derivatives, e.g.
N-(2,6-difluorophenyl)-7-methyl-1,2,4-triazolo[1,5-c]pyrimidine-2-sulfonamide (flumetsulam),
N-(2,6-dichloro-3-methylphenyl)-5,7-dimethoxy-1,2,4-triazolo[1,5-c]pyrimidine-2-sulfonamide,
N-(2,6-difluorophenyl)-7-fluoro-5-methoxy-1,2,4-triazolo[1,5-c]pyrimidine-2-sulfonamide,
N-(2,6-dichloro-3-methylphenyl)-7-chloro-5-methoxy-1,2,4-triazolo[1,5-c]pyrimidine-2-sulfonamide,
N-(2-chloro-6-methoxycarbonyl)-5,7-dimethyl-1,2,4-triazolo[1,5-c]pyrimidine-2-sulfonamide (EP-A 0 343 752, U.S. Pat. No. 4,988,812);
   D) pyrimidinyloxypyridinecarboxylic acid or pyrimidinyloxybenzoic acid derivatives, e.g.
benzyl 3-(4,6-dimethoxypyrimidin-2-yl)oxypyridine-2-carboxylic acid (EP-A 0 249 707),
methyl 3-(4,6-dimethoxypyrimidin-2-yl)oxypyridine-2-carboxylic acid (EP-A 0 249 707),
2,6-bis[(4,6-dimethoxypyrimidin-2-yl)oxy]benzoic acid (EP-A 0 321 846),
1-(ethoxycarbonyloxyethyl) 2,6-bis[(4,6-dimethoxypyrimidin-2-yl)oxy]benzoate (EP-A 0 472 113).

Suitable herbicidal active substances other than ALS inhibitors which can be present in the microemulsion concentrates according to the invention as component are, for example:

E) herbicides of the type of the phenoxyphenoxy- and heteroaryloxyphenoxycarboxylic acid derivatives, such as
E1) phenoxyphenoxy- and benzyloxyphenoxycarboxylic acid derivatives, e.g.
methyl 2-(4-(2,4-dichlorophenoxy)phenoxy)propionate (diclofop-methyl),
methyl 2-(4-(4-bromo-2-chlorophenoxy)phenoxy)propionate (DE-A 26 01 548),
methyl 2-(4-(4-bromo-2-fluorophenoxy)phenoxy)propionate (U.S. Pat. No. 4,808,750),
methyl 2-(4-(2-chloro-4-trifluoromethylphenoxy)phenoxy)propionate (DE-A 24 33 067),
methyl 2-(4-(2-fluoro-4-trifluoromethylphenoxy)phenoxy)propionate (U.S. Pat. No. 4,808,750),
methyl 2-(4-(2,4-dichlorobenzyl)phenoxy)propionate (DE-A 24 17 487),
ethyl 4-(4-(4-trifluoromethylphenoxy)phenoxy)pent-2-enoate,
methyl 2-(4-(4-trifluoromethylphenoxy)phenoxy)propionate (DE-A 24 33 067);
   E2) “mononuclear” heteroaryloxyphenoxyalkanecarboxylic acid derivatives, e.g.
ethyl 2-(4-(3,5-dichloropyridyl-2-oxy)phenoxy)propionate (EP-A 0 002 925),
propargyl 2-(4-(3,5-dichloropyridyl-2-oxy)phenoxy)propionate (EP-A 0 003 114),
methyl 2-(4-(3-chloro-5-trifluoromethyl-2-pyridyloxy)phenoxy)propionate (EP-A 0 003 890),
ethyl 2-(4-(3-chloro-5-trifluoromethyl-2-pyridyloxy)phenoxy)propionate (EP-A 0 003 890),
propargyl 2-(4-(5-chloro-3-fluoro-2-pyridyloxy)phenoxy)propionate (EP-A 0 191 736),
butyl 2-(4-(5-trifluoromethyl-2-pyridyloxy)phenoxy)propionate (fluazifop-butyl);
   E3) “binuclear” heteroaryloxyphenoxyalkanecarboxylic acid derivatives, e.g.
methyl and ethyl 2-(4-(6-chloro-2-quinoxalyloxy)phenoxy)propionate (quizalofopmethyl and quizalofop-ethyl),
methyl 2-(4-(6-fluoro-2-quinoxalyloxy)phenoxy)propionate (see J. Pest. Sci., Vol. 10, 61 (1985)),
2-isopropylideneaminooxyethyl 2-(4-(6-chloro-2-quinoxalyloxy)phenoxy)propionate (propaquizafop),
ethyl 2-(4-(6-chlorobenzoxazol-2-yloxy)phenoxy)propionate (fenoxaprop-ethyl), the D(+) isomer thereof (fenoxaprop-P-ethyl) and ethyl 2-(4-(6-chlorobenzothiazol-2-yloxy)phenoxy)propionate (DE-A 26 40 730),
tetrahydrofur-2-ylmethyl 2-(4-(6-chloroquinoxalyloxy)phenoxy)propionate (EP-A 0 323 727);
   F) chloroacetanilides, e.g.
N-methoxymethyl-2,6-diethylchloroacetanilide (alachlor),
N-(3-methoxyprop-2-yl)-2-methyl-6-ethylchloroacetanilide (metolachlor),
N-(3-methyl-1,2,4-oxadiazol-5-ylmethyl)chloroacetic acid 2,6-dimethylanilide,
N-(2,6-dimethylphenyl)-N-(1-pyrazolylmethyl)chloroacetamide (metazachlor);
   G) thiocarbamates, e.g.
S-ethyl N,N-dipropylthiocarbamate (EPTC),
S-ethyl N,N-diisobutylthiocarbamate (butylate);
   H) cyclohexanedione oximes, e.g.
methyl 3-(1-allyloxyiminobutyl)-4-hydroxy-6,6-dimethyl-2-oxocyclohex-3-enecarboxylate, (alloxydim),
2-(1-ethoxyiminobutyl)-5-(2-ethylthiopropyl)-3-hydroxycyclohex-2-en-1-one (sethoxydim),
2-(1-ethoxyiminobutyl)-5-(2-phenylthiopropyl)-3-hydroxycyclohex-2-en-1-one (cloproxydim),
2-(1-(3-chloroallyloxyimino)butyl)-5-(2-ethylthiopropyl)-3-hydroxycyclohex-2-en-1-one,
2-(1-(3-chloroallyloxyimino)propyl)-5-(2-ethylthiopropyl)-3-hydroxycyclohex-2-en-1-one (clethodim),
2-(1-ethoxyiminobutyl)-3-hydroxy-5-(thian-3-yl)cyclohex-2-enone (cycloxydim),
2-(1-ethoxyiminopropyl)-5-(2,4,6-trimethylphenyl)-3-hydroxycyclohex-2-en-1-one (tralkoxydim);
   I) benzoylcyclohexanediones, e.g.
2-(2-chloro-4-(methylsulfonyl)benzoyl)cyclohexane-1,3-dione (SC-0051, EP-A 0 137 963), 2-(2-nitrobenzoyl)-4,4-dimethylcyclohexane-1,3-dione (EP-A 0 274 634),
2-(2-nitro-4-(methylsulfonyl)benzoyl)-4,4-dimethylcyclohexane-1,3-dione (WO 91/13548, mesotrione);
   J) S—(N-aryl-N-(alkyl)carbamoylmethyl) dithiophosphoric acid esters, such as S—[N-(4-chlorophenyl)-N-(isopropyl)carbamoylmethyl] O,O-dimethyl dithiophosphate (anilophos);
   K) alkylazines, e.g. as described in WO-A 97/08156, WO-A 97/31904, DE-A-19826670, WO-A 98/15536, WO-A 8/15537, WO-A 98/15538, WO-A 98/15539, and also DE-A-19828519, WO-A 98/34925, WO-A 98/42684, WO-A 99/18100, WO-A 99/19309, WO-A 99/37627 and WO-A 99/65882, preferably those of the formula (K)

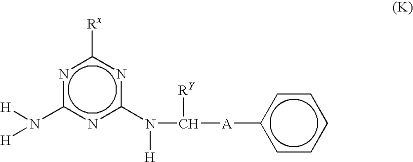

in which
R^{X} is (C₁-C₄)-alkyl or (C₁-C₄)-haloalkyl;
R^{Y} is (C₁-C₄)-alkyl, (C₃-C₆)-cycloalkyl or (C₃-C₆)-cycloalkyl-(C₁-C₄)-alkyl and
A is —CH₂—, —CH₂—CH₂—, —CH₂—CH₂—CH₂—, —O—, —CH₂—CH₂—O—, —CH₂—CH₂—CH₂—O—, particularly preferably those of the formulae K1-K7

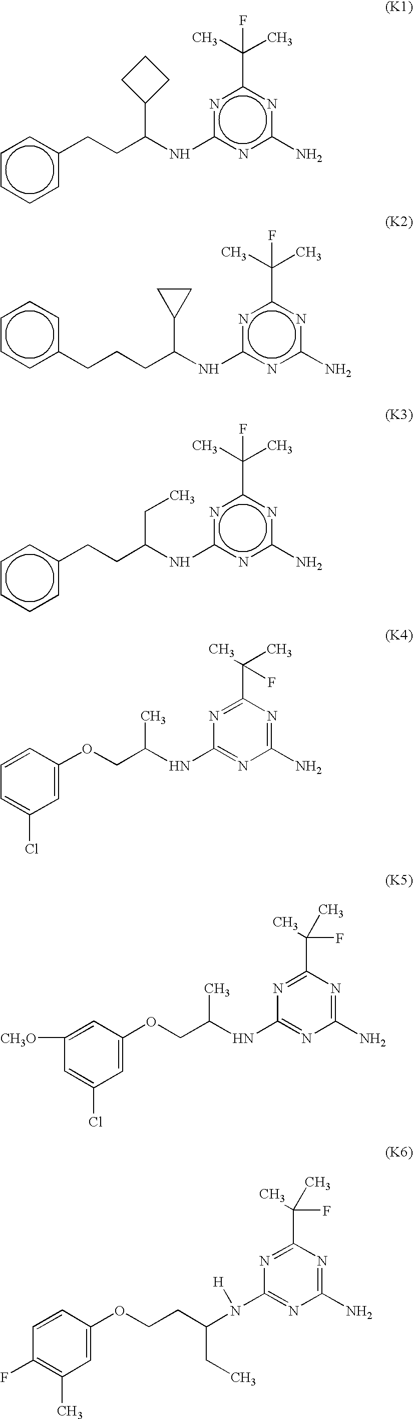

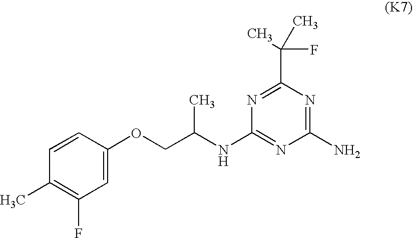

L) phosphorus-comprising herbicides, e.g. one or more compounds of the formula (IV) or derivatives thereof, such as salts,

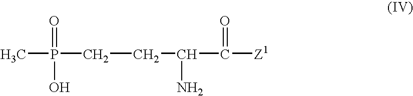

in which
Z¹ is a radical of the formula —OM, —NHCH(CH₃)CONHCH(CH₃)CO₂M or —NHCH(CH₃)CONHCH[CH₂CH(CH₃)₂]CO₂M and
M=H or a salt-forming cation,
and/or one or more compounds of the formula (V) or the derivatives thereof, such as salts,

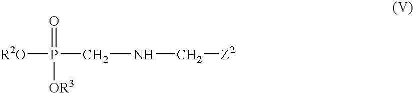

in which
Z² is a radical of the formula CN or CO₂R¹, in which R¹=Q or is a salt-forming cation and in which connection Q=H, alkyl, alkenyl, alkoxyalkyl or C₆-C₁₀-aryl, which is unsubstituted or substituted and is preferably unsubstituted or substituted by one or more radicals from the group consisting of alkyl, alkoxy, halogen, CF₃, NO₂ and CN, and
R² and R³ are, in each case independently of one another, H, alkyl, C₆-C₁₀-aryl, which is unsubstituted or substituted and is preferably unsubstituted or substituted by one or more radicals from the group consisting of alkyl, alkoxy, halogen, CF₃, NO₂ and CN, or biphenyl or a salt-forming cation.

Examples of active substances of the formulae (IV) and (V) are as follows:
glufosinate and the ammonium salts thereof in racemic form, i.e. 2-amino-4-[hydroxy(methyl)phosphinoyl]butyric acid or the ammonium salt thereof,
the L-enantiomer of glufosinate and the ammonium salt thereof,
bilanafos/bialaphos, i.e. L-2-amino-4-[hydroxy(methyl)phosphinoyl]butyryl-L-alanyl-L-alanine and the sodium salt thereof,
glyphosate;
   M) carbamates, e.g. asulam, carbetamide, chloropham and propham;
   N) benzofurans, e.g. benfuresate and ethofumesate;
   O) plant hormones;
   P) auxins and auxin analogs, e.g. 4-indole-3-butyric acid, indole-3-acetic acid, 1-naphthyleneacetic acid, 2-(1-naphthyl)acetamide and 2-naphthyloxyacetic acid;
   Q) cytokinins, e.g. kinetin and 6-benzylaminopurine;
   R) gibberellins, e.g. gibberellic acid, gibberellin A4 and A7;
   S) abscisic acid and the derivatives thereof;
   T) ethylene precursors, e.g. ethephone;

U) herbicides from the group consisting of fatty acid synthase inhibitors;

V) ureas, e.g. chlorotoluron, dimefuron, diuron, fluometuron, isoproturon, isouron, karbutilate, linuron, methabenzthiazuron, metobenzuron, metoxuron, monolinuron, neburon, siduron and tebuthiuron and
W) metamitron;
X) hydroxybenzonitriles, e.g. such as bromoxynil and ioxynil and the salts and esters thereof, such as bromoxynil octanoate and ioxynil octanoate.

The agrochemical active substances can also be growth regulators. Examples of these are tribufos, cyclanilide and thidiazuron.

The herbicides (plant growth regulators) of groups A to X are known, for example, from each of the documents mentioned above and/or from “The Pesticide Manual”, 12^{th} edition (2000) and 13^{th} edition (2003), The British Crop Protection Council, “Agricultural Chemicals Book II—Herbicides—”, by W. T. Thompson, Thompson Publications, Fresno Calif., USA, 1990, and “Farm Chemicals Handbook '90”, Meister Publishing Company, Willoughby Ohio, USA, 1990.

The following are preferred for fungicides (bactericides), insecticides (acaricides, nematicides) and herbicides (plant growth regulators):

atrazine, acetochior, aclonifen, alachlor, amidochlor, amidosulfuron, azimsulfuron, alloxydim, amitraz, anilofos, asulam, acetamiprid, acrinathrin, aldicarb, azinphos-methyl, amicarbazone, bentazon, bensulfuron(-methyl), bromoxynil (octanoate/heptanoate), butachlor, bispyribac(-sodium), benzobicyclon, benzofenap, butroxydim, bitertanol, bromuconazole, benfuresate, beta-cyfluthrin, chlorsulfuron, chlorimuron, clomazone, clopyralid, cinosulfuron, cyclosulfamuron, clethodim, clodinafop-propargyl, cycloxydim, cyhalofop-butyl, cypermethrin, carbaryl, cyfluthrin, cyanazine, 2,4-D-ester, 2,4-DB-ester, 2,4-DP-ester, CMPP-ester, cyclanilide, carbendazim, carpropamid, cyproconazole, chlortoluron, diclofop-methyl, desmedipham, diflufenican, dicamba, deltamethrin, diuron, EPTC, ethoxysulfuron, ethofumesate, ethephon, edifenphos, endosulfan, ethoprophos, flazasulfuron, florasulam, flucarbazone(-sodium), flumetsulam, flufenacet, fluoroglycofen, fluoroxypyr, flupyrsulfuron, foramsulfuron, flumioxazin, flumiclorac, fomesafen, fenoxaprop, fenoxaprop-ethyl, fenoxaprop-P, fenoxaprop-P-ethyl, fluazifop, fluazifop-P-butyl, fluazifop-butyl, fipronil, fenamidone, fenhexamid, fentins, fluquinconazole, fosetyl-aluminum, fentrazamide, flurtamone, fenamiphos, fenthion, glufosinate(-ammonium), glyphosate, halosulfuron, haloxyfop, haloxyfop-P, haloxyfop-etotyl, haloxyfop-P-methyl, imazamox, imazapic, imazethapyr, imazaquin, imazapyr, imazosulfuron, iodosulfuron, iodosulfuron-methyl, ioxynil (octanoate), isoxaflutole and the diketonitriles thereof, isoxachiortole, imidacloprid, isoxadifen-ethyl, iprodione, iprovalicarb, isoproturon, MCPA-ester, MCPB, mesotrione, metamifop, metosulam, mesosulfuron(-methyl), (S-)metolachlor, metsulfuron-methyl, metamitron, metribuzin, mefenpyr-diethyl, mefenacet, methamidophos, methiocarb, nicosulfuron, niclosamide, lactofen, linuron, oxyfluorfen, oxazinone, oxadiargyl, oxadiazon, oxydemeton-methyl, pendimethalin, phenmedipham, picloram, pinoxaden, primisulfuron-methyl, prosulfuron, propanil, propoxycarbazone(-sodium), pyrazosulfuron(-methyl), profoxydim, propaquizafop, pyrazolynate, pyrazoxyfen, prochloraz, pencycuron, propamocarb HCl, propineb, pyrimethanil, phosalone, prothiofos, quizalofop-P-tefuryl, quizalofop-P-ethyl, rimsulfuron, sulfentrazone, sulfosulfuron, sulfometuron, sethoxydim, sulcotrione, spiroxamine, silafluofen, terbuthylazine, thifensulfuron, triasulfuron, tribenuron, triclopyr, triflusulfuron-methyl, trifluralin, tritosulfuron, topramezone, tepraloxydim, tralkoxydim, terbufos, thidiazuron, tebuconazole, tolylfluanid-dichlofluanid, triadimefon, triadimenol, trifloxystrobin, thiacloprid, thiodicarb, tralomethrin, triazophos, trichlorfon, triflumuron, triticonazole and isoxapyrifop, and, if appropriate, the esters and salts thereof.

The agrochemical active substances listed above are, e.g., known from “The Pesticide Manual”, 12^{th} edition (2000) and 13^{th} edition (2003), The British Crop Protection Council, or the literature references listed after the individual active substances.

The agrochemical active substances can also be safeners. Examples of these are, inter alia:

a) compounds of the formulae (S-II) to (S-IV)

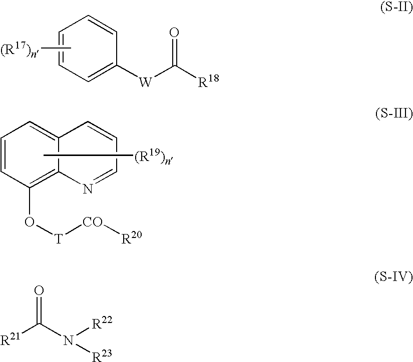

in which the symbols and indices have the following meanings:
n′ is a natural number from 0 to 5, preferably from 0 to 3;
T is a (C₁ or C₂)-alkanediyl chain which is unsubstituted or substituted with one or two (C₁-C₄)-alkyl radicals or with [(C₁-C₃)-alkoxy]carbonyl;
W is an unsubstituted or substituted divalent heterocyclic radical from the group consisting of partially unsaturated or aromatic five-membered heterocycles with 1 to 3 ring heteroatoms of the N or O type, at least one nitrogen atom and at most one oxygen atom being present in the ring, preferably a radical from the group consisting of (W1) to (W4),

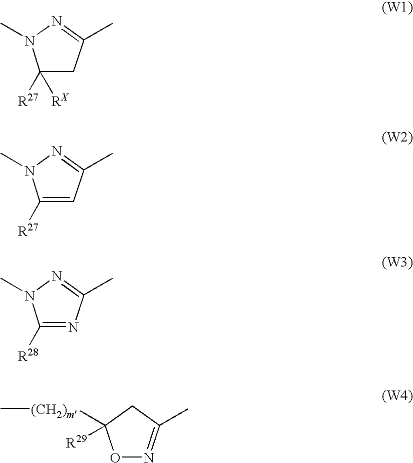

m′ is 0 or 1;
R¹⁷ and R¹⁹ are, identically or differently, halogen, (C₁-C₄)-alkyl, (C₁-C₄)-alkoxy, nitro or (C₁-C₄)-haloalkyl;
R¹⁸ and R²⁰ are, identically or differently, OR²⁴, SR²⁴ or NR²⁴R²⁵ or a saturated or unsaturated 3- to 7-membered heterocycle with at least one nitrogen atom and up to 3 heteroatoms, preferably from the group consisting of O and S, which is bonded via the nitrogen atom to the carbonyl group in (S-II) or (S-III) and is unsubstituted or substituted by radicals from the group consisting of (C₁-C₄)-alkyl, (C₁-C₄)-alkoxy and, if appropriate, substituted phenyl,
   preferably a radical of the formula OR²⁴, NHR²⁵ or N(CH₃)₂, in particular of the formula OR²⁴;
R²⁴ is hydrogen or an unsubstituted or substituted aliphatic hydrocarbon radical, preferably with a total of 1 to 18 carbon atoms;
R²⁵ is hydrogen, (C₁-C₆)-alkyl, (C₁-C₆)-alkoxy or substituted or unsubstituted phenyl;
R^{X} is H, (C₁-C₈)-alkyl, (C₁-C₈)-haloalkyl, (C₁-C₄)-alkoxy-(C₁-C₈)-alkyl, cyano or COOR²⁸, in which R²⁶ is hydrogen, (C₁-C₈)-alkyl, (C₁-C₈)-haloalkyl, (C₁-C₄)-alkoxy-(C₁-C₄)-alkyl, (C₁-C₈)-hydroxyalkyl, (C₃-C₁₂)-cycloalkyl or tri-(C₁-C₄)-alkyl-silyl;
R²⁷, R²⁸ and R²⁹ are, identically or differently, hydrogen, (C₁-C₈)-alkyl, (C₁-C₈)-haloalkyl, (C₃-C₁₂)-cycloalkyl or substituted or unsubstituted phenyl;
R²¹ is (C₁-C₄)-alkyl, (C₁-C₄)-haloalkyl, (C₂-C₄)-alkenyl, (C₂-C₄)-haloalkenyl, (C₃-C₇)-cycloalkyl, preferably dichloromethyl;
R²² and R²³ are, identically or differently, hydrogen, (C₁-C₄)-alkyl, (C₂-C₄)-alkenyl, (C₂-C₄)-alkynyl, (C₁-C₄)-haloalkyl, (C₂-C₄)-haloalkenyl, (C₁-C₄)-alkylcarbamoyl-(C₁-C₄)-alkyl, (C₂-C₄)-alkenylcarbamoyl-(C₁-C₄)-alkyl, (C₁-C₄)-alkoxy-(C₁-C₄)-alkyl, dioxolanyl-(C₁-C₄)-alkyl, thiazolyl, furyl, furylalkyl, thienyl, piperidyl, substituted or unsubstituted phenyl, or R²² and R²³ together form a substituted or unsubstituted heterocyclic ring, preferably an oxazolidine, thiazolidine, piperidine, morpholine, hexahydropyrimidine or benzoxazine ring;
   preferably safeners of the following subgroups of compounds of the formulae (S-II) to (S-IV):
   compounds of the type of dichlorophenylpyrazoline-3-carboxylic acid (i.e., of the formula (S-II) in which W=(W1) and (R¹⁷)_{n′}=2,4-Cl₂), preferably compounds such as ethyl 1-(2,4-dichlorophenyl)-5-(ethoxycarbonyl)-5-methyl-2-pyrazoline-3-carboxylate (1′-1, mefenpyr-diethyl), mefenpyr-dimethyl and mefenpyr (II-0), and related compounds, such as those described in WO-A-91/07874;
   derivatives of dichlorophenylpyrazolecarboxylic acid (i.e., of the formula (S-II) in which W=(W2) and (R¹⁷)_{n′}=2,4-Cl₂), preferably compounds such as ethyl 1-(2,4-dichlorophenyl)-5-methylpyrazole-3-carboxylate (II-2), ethyl 1-(2,4-dichlorophenyl)-5-isopropylpyrazole-3-carboxylate (II-3), ethyl 1-(2,4-dichlorophenyl)-5-(1,1-dimethylethyl)pyrazole-3-carboxylate (II-4), ethyl 1-(2,4-dichlorophenyl)-5-phenylpyrazole-3-carboxylate (II-5) and related compounds, such as described in EP-A-0 333 131 and EP-A-0 269 806;
   compounds of the type of triazolecarboxylic acids (i.e., of the formula (S-II) in which W=(W3) and (R¹⁷)_{n′}=2,4-Cl₂), preferably compounds such as fenchlorazole-ethyl, i.e. ethyl 1-(2,4-dichlorophenyl)-5-trichloromethyl-(1H)-1,2,4-triazole-3-carboxylate (II-6), and related compounds (see EP-A-0 174 562 and EP-A-0 346 620);
   compounds of the type of 5-benzyl- or 5-phenyl-2-isoxazoline-3-carboxylic acid or of 5,5-diphenyl-2-isoxazoline-3-carboxylic acid, such as isoxadifen (II-12), (in which W=(W4)), preferably compounds such as ethyl 5-(2,4-dichlorobenzyl)-2-isoxazoline-3-carboxylate (II-7) or ethyl 5-phenyl-2-isoxazoline-3-carboxylate (II-8), and related compounds, as described in WO-A-91/08202, or of ethyl 5,5-diphenyl-2-isoxazolinecarboxylate (II-9, isoxadifen-ethyl) or -n-propyl 5,5-diphenyl-2-isoxazoline carboxylate (II-10) or of ethyl 5-(4-fluorophenyl)-5-phenyl-2-isoxazoline-3-carboxylate (II-11), as described in WO-A-95/07897;
   compounds of the type of 8-quinolineoxyacetic acid, e.g. those of the formula (S-III) in which (R¹⁹)_{n′}=5-Cl, R²⁰=OR²⁴ and T=CH₂, preferably the compounds 1-methylhexyl (5-chloro-8-quinolinoxy)acetate (III-1, cloquintocet-mexyl), 1,3-dimethylbut-1-yl (5-chloro-8-quinolinoxy)acetate (III-2), 4-allyloxybutyl (5-chloro-8-quinolinoxy)acetate (III-3), 1-allyloxyprop-2-yl (5-chloro-8-quinolinoxy)acetate (III-4), ethyl (5-chloro-8-quinolinoxy)acetate (III-5), methyl (5-chloro-8-quinolinoxy)acetate (III-6), allyl (5-chloro-8-quinolinoxy)acetate (III-7), 2-(2-propylideneiminoxy)-1-ethyl (5-chloro-8-quinolinoxy)acetate (III-8), 2-oxo-prop-1-yl (5-chloro-8-quinolinoxy)acetate (III-9), (5-chloro-8-quinolinoxy)acetic acid (III-10) and the salts thereof, such as described, e.g., in WO-A-02/34048, and related compounds, such as described in EP-A-0 860 750, EP-A-0 094 349 and EP-A-0 191 736 or EP-A-0 492 366;
   compounds of the type of (5-chloro-8-quinolinoxy)malonic acid, i.e. of the formula (S-III) in which (R¹⁹)_{n′}=5-Cl, R²⁰=OR²⁴ and T=—CH(COO-alkyl)-, preferably the compounds diethyl (5-chloro-8-quinolinoxy)malonate (III-11), diallyl (5-chloro-8-quinolinoxy)malonate, methyl ethyl (5-chloro-8-quinolinoxy)malonate and related compounds, as described in EP-A-0 582 198;
   compounds of the type of dichloroacetamides, i.e. of the formula (S-IV), preferably: N,N-diallyl-2,2-dichloroacetamide (dichloromid (IV-1), from U.S. Pat. No. 4,137,070), 4-dichloroacetyl-3,4-dihydro-3-methyl-2H-1,4-benzoxazine (IV-2, benoxacor, from EP 0 149 974), N1,N2-diallyl-N2-dichloroacetylglycinamide (DKA-24 (IV-3), from HU 2143821), 4-dichloroacetyl-1-oxa-4-azaspiro[4,5]decane (AD-67), 2,2-dichloro-N-(1,3-dioxolan-2-ylmethyl)-N-(2-propenyl)acetamide (PPG-1292), 3-dichloroacetyl-2,2,5-trimethyloxazolidine (R-29148, IV-4), 3-dichloroacetyl-2,2-dimethyl-5-phenyloxazolidine, 3-dichloroacetyl-2,2-dimethyl-5-(2-thienyl)oxazolidine, 3-dichloroacetyl-5-(2-furanyl)-2,2-dimethyloxazolidine (furilazole (IV-5), MON 13900), 1-dichloroacetyl-hexahydro-3,3,8a-trimethylpyrrolo[1,2-a]pyrimidin-6(2H)-one (dicyclonon, BAS145138);
      b) one or more compounds from the group consisting of:
      1,8-naphthalic anhydride, methyl diphenylmethoxyacetate, 1-(2-chlorobenzyl)-3-(1-methyl-1-phenylethyl)urea (cumyluron), O,O-diethyl S-2-ethylthioethyl phosphorodithioate (disulfoton), 4-chlorophenyl methylcarbamate (mephenate), O,O-diethyl O-phenylphosphorothioate (dietholate), 4-carboxy-3,4-dihydro-2H-1-benzopyran-4-acetic acid (CL-304415, CAS Reg. No.: 31541-57-8), cyanomethoxyimino(phenyl)acetonitrile (cyometrinil), 1,3-dioxolan-2-ylmethoxyimino(phenyl)acetonitrile (oxabetrinil), 4′-chloro-2,2,2-trifluoroacetophenone O-1,3-dioxolan-2-ylmethyloxime (fluxofenim), 4,6-dichloro-2-phenylpyrimidine (fenclorim), benzyl 2-chloro-4-trifluoromethyl-1,3-thiazole-5-carboxylate (flurazole), 2-dichloromethyl-2-methyl-1,3-dioxolane (MG-191), N-(4-methylphenyl)-N′-(1-methyl-1-phenylethyl)urea (dymron), (2,4-dichlorophenoxy)acetic acid (2,4-D), (4-chlorophenoxy)acetic acid, (R,S)-2-(4-chloro-o-tolyloxy)propionic acid (mecoprop), 4-(2,4-dichlorophenoxy)butyric acid (2,4-DB), (4-chloro-o-tolyloxy)acetic acid (MCPA), 4-(4-chloro-o-tolyloxy)butyric acid, 4-(4-chlorophenoxy)butyric acid, 3,6-dichloro-2-methoxybenzoic acid (dicamba), 1-(ethoxycarbonyl)ethyl 3,6-dichloro-2-methoxybenzoate (lactidichlor) and also the salts and esters thereof, preferably (C₁-C₈);
      c) N-acylsulfonamides of the formula (S-V) and their salts,

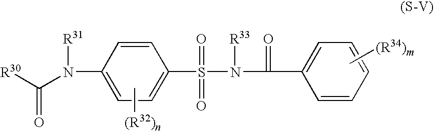

in which
R³⁰ is hydrogen, a hydrocarbon radical, a hydrocarbyloxy radical, a hydrocarbylthio radical or a heterocyclyl radical which is preferably bonded via a carbon atom, each of the 4 last-mentioned radicals being unsubstituted or substituted by one or more identical or different radicals from the group consisting of halogen, cyano, nitro, amino, hydroxyl, carboxyl, formyl, carboxamide, sulfonamide and radicals of the formula —Z^{a}—R^{a},
   each hydrocarbon part preferably exhibiting from 1 to 20 carbon atoms and a carbon-comprising radical R³⁰ inclusive of substituents preferably exhibiting from 1 to 30 carbon atoms;
R³¹ is hydrogen or (C₁-C₄)-alkyl, preferably hydrogen, or
R³⁰ and R³¹, together with the group of the formula —CO—N—, are the radical of a saturated or unsaturated 3- to 8-membered ring;
R³² is, identically or differently, halogen, cyano, nitro, amino, hydroxyl, carboxyl, formyl, CONH₂, SO₂NH₂ or a radical of the formula —Z^{b}—R^{b};
R³³ is hydrogen or (C₁-C₄)-alkyl, preferably H;
R³⁴ is, identically or differently, halogen, cyano, nitro, amino, hydroxyl, carboxyl, CHO, CONH₂, SO₂NH₂ or a radical of the formula —Z^{c}—R^{c};
R^{a} is a hydrocarbon radical or a heterocyclyl radical, each of the two last-mentioned radicals being unsubstituted or substituted by one or more identical or different radicals from the group consisting of halogen, cyano, nitro, amino, hydroxyl, mono- and di[(C₁-C₄)-alkyl]amino, or an alkyl radical in which several, preferably 2 or 3, nonneighboring CH₂ groups are in each case replaced by an oxygen atom;
R^{b} and R^{c} are, identically or differently, a hydrocarbon radical or heterocyclyl radical, each of the two last-mentioned radicals being unsubstituted or substituted by one or more identical or different radicals from the group consisting of halogen, cyano, nitro, amino, hydroxyl, phosphoryl, halo-(C₁-C₄)-alkoxy, mono- and di[(C₁-C₄)-alkyl]amino, or an alkyl radical in which several, preferably 2 or 3, nonneighboring CH₂ groups are in each case replaced by an oxygen atom;
Z^{a} is a divalent group of the formula —O—, —S—, —CO—, —CS—, —CO—O—, —CO—S—, —O—CO—, —S—CO—, —SO—, —SO₂—, —NR*—, —CO—NR*—, —NR*—CO—, —SO₂—NR*— or —NR*—SO₂—, the bond indicated on the right of the respective divalent group being the bond to the R^{a} radical and the R* in the 5 last-mentioned radicals being, independently of one another, in each case H, (C₁-C₄)-alkyl or halo-(C₁-C₄)-alkyl;
Z^{b} and Z^{c} are, independently of one another, a direct bond or a divalent group of the formula —O—, —S—, —CO—, —CS—, —CO—O—, —CO—S—, —O—CO—, —S—CO—, —SO—, —SO₂—, —NR*—, —SO₂—NR*—, —NR*—SO₂—, —CO—NR*— or —NR*—CO—, the bond indicated on the right of the respective divalent group being the bond to the R^{b} or R^{c} radical and the R* in the 5 last-mentioned radicals being, independently of one another, in each case H, (C₁-C₄)-alkyl or halo-(C₁-C₄)-alkyl;
n is an integer from 0 to 4, preferably 0, 1 or 2, in particular 0 or 1, and
m is an integer from 0 to 5, preferably 0, 1, 2 or 3, in particular 0, 1 or 2; preferably safeners of compounds of the formula (ω-V) in which
   R³⁰=H₃C—O—CH₂—, R³¹=R³³=H, R³⁴=2-OMe (V-1),
   R³⁰=H₃C—O—CH₂—, R³¹=R³³=H, R³⁴=2-OMe-5-Cl (V-2),
   R³⁰=cyclopropyl, R³¹=R³³=H, R³⁴=2-OMe (V-3),
   R³⁰=cyclopropyl, R³¹=R³³=H, R³⁴=2-OMe-5-Cl (V-4),
   R³⁰=cyclopropyl, R³¹=R³³=H, R³⁴=2-Me (V-5),
   R³⁰=tert-butyl, R³¹=R³³=H, R³⁴=2-OMe (V-6).
      d) Acylsulfamoylbenzamides of the general formula (ω-VI), if appropriate also in salt form,

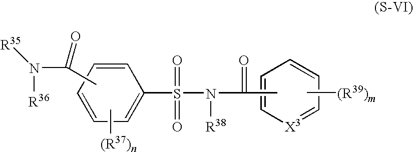

in which
X³ is CH or N;
R³⁵ is hydrogen, heterocyclyl or a hydrocarbon radical, the two last-mentioned radicals being, if appropriate, substituted by one or more identical or different radicals from the group consisting of halogen, cyano, nitro, amino, hydroxyl, carboxyl, CHO, CONH₂, SO₂NH₂ and Z^{a}—R^{a};
R³⁶ is hydrogen, hydroxyl, (C₁-C₆)-alkyl, (C₂-C₆)-alkenyl, (C₂-C₆)-alkynyl, (C₁-C₆)-alkoxy, (C₂-C₆)-alkenyloxy, the five last-mentioned radicals being, if appropriate, substituted by one or more identical or different radicals from the group consisting of halogen, hydroxyl, (C₁-C₄)-alkyl, (C₁-C₄)-alkoxy and (C₁-C₄)-alkylthio, or
R³⁵ and R³⁶ are, together with the nitrogen atom carrying them, a saturated or unsaturated 3- to 8-membered ring;
R³⁷ is halogen, cyano, nitro, amino, hydroxyl, carboxyl, CHO, CONH₂, SO₂NH₂ or Z^{b}—R^{b};
R³⁸ is hydrogen, (C₁-C₄)-alkyl, (C₂-C₄)-alkenyl or (C₂-C₄)-alkynyl;
R³⁹ is halogen, cyano, nitro, amino, hydroxyl, carboxyl, phosphoryl, CHO, CONH₂, SO₂NH₂ or Z^{c}—R^{c};
R^{a} is a (C₂-C₂₀)-alkyl radical, the carbon chain of which is interrupted one or more times by oxygen atoms, heterocyclyl or a hydrocarbon radical, the two last-mentioned radicals being, if appropriate, substituted by one or more identical or different radicals from the group consisting of halogen, cyano, nitro, amino, hydroxyl, mono- and di[(C₁-C₄)-alkyl]amino;
R^{b} and R^{c} are, identically or differently a (C₂-C₂₀)-alkyl radical, the carbon chain of which is interrupted one or more times by oxygen atoms, heterocyclyl or a hydrocarbon radical, the two last-mentioned radicals being, if appropriate, substituted by one or more identical or different radicals from the group consisting of halogen, cyano, nitro, amino, hydroxyl, phosphoryl, (C₁-C₄)-haloalkoxy, mono- and di[(C₁-C₄)-alkyl]amino;
Z^{a} is a divalent unit from the group consisting of O, S, CO, CS, C(O)O, C(O)S, SO, SO₂, NR^{d}, C(O)NR^{d} or SO₂NR^{d};
Z^{b} and Z^{c} are, identically or differently, a direct bond or a divalent unit from the group consisting of O, S, CO, CS, C(O)O, C(O)S, SO, SO₂, NR^{d}, SO₂NR^{d} or C(O)NR^{d};
R^{d} is hydrogen, (C₁-C₄)-alkyl or (C₁-C₄)-haloalkyl;
n is an integer from 0 to 4, and
m is an integer from 0 to 5 in the case where X is CH and an integer from 0 to 4 in the case where X is N;
   preferably safeners of compounds of the formula (S-VI) in which
X³ is CH;
R³⁵ is hydrogen, (C₁-C₆)-alkyl, (C₃-C₆)-cycloalkyl, (C₂-C₆)-alkenyl, (C₅-C₆)-cycloalkenyl, phenyl or 3- to 6-membered heterocyclyl with up to three heteroatoms from the group consisting of nitrogen, oxygen and sulfur, it being possible for the six last membered radicals, if appropriate, to be substituted by one or more identical or different substituents from the group consisting of halogen, (C₁-C₆)-alkoxy, (C₁-C₆)-haloalkoxy, (C₁-C₂)-alkylsulfinyl, (C₁-C₂)-alkylsulfonyl, (C₃-C₆)-cycloalkyl, (C₁-C₄)-alkoxycarbonyl, (C₁-C₄)-alkylcarbonyl and phenyl and, in the case of cyclic radicals, also (C₁-C₄)-alkyl and (C₁-C₄)-haloalkyl;
R³⁶ is hydrogen, (C₁-C₆)-alkyl, (C₂-C₆)-alkenyl, (C₂-C₆)-alkynyl, the three last-mentioned radicals being, if appropriate, substituted by one or more identical or different substituents from the group consisting of halogen, hydroxyl, (C₁-C₄)-alkyl, (C₁-C₄)-alkoxy and (C₁-C₄)-alkylthio;
R³⁷ is halogen, (C₁-C₄)-haloalkyl, (C₁-C₄)-haloalkoxy, nitro, (C₁-C₄)-alkyl, (C₁-C₄)-alkoxy, (C₁-C₄)-alkylsulfonyl, (C₁-C₄)-alkoxycarbonyl or (C₁-C₄)-alkylcarbonyl;
R³⁸ is hydrogen;
R³⁹ is halogen, nitro, (C₁-C₄)-alkyl, (C₁-C₄)-haloalkyl, (C₁-C₄)-haloalkoxy, (C₃-C₆)-cycloalkyl, phenyl, (C₁-C₄)-alkoxy, cyano, (C₁-C₄)-alkylthio, (C₁-C₄)-alkylsulfinyl, (C₁-C₄)-alkylsulfonyl, (C₁-C₄)-alkoxycarbonyl or (C₁-C₄)-alkylcarbonyl;
n is 0, 1 or 2 and
m is 1 or 2;

in particular compounds of the type of acylsulfamoylbenzamides of the following formula (S-VII) which are known, e.g., from WO-A-99/16744,

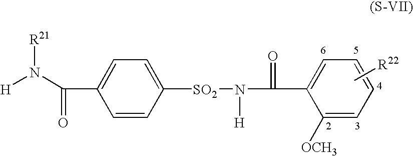

in which
R²¹=cyclopropyl and R²²=H(S3-1=4-cyclopropylaminocarbonyl-N-(2-methoxybenzoyl)benzenesulfonamide; cyprosulfamide);
R²¹=cyclopropyl and R²²=5-Cl (S3-2),
R²¹=ethyl and R²²=H(S3-3),
R²¹=isopropyl and R²²=5-Cl (S3-4) and
R²¹=isopropyl and R²²=H(S3-5=4-isopropylaminocarbonyl-N-(2-methoxybenzoyl)benzenesulfonamide);
   e) compounds of the type of N-acylsulfamoylphenylureas of the formula (S-VIII) which are known, e.g., from EP-A-365484,

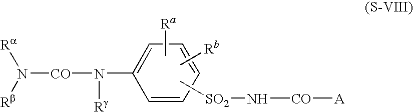

in which
A is a radical from the group consisting of

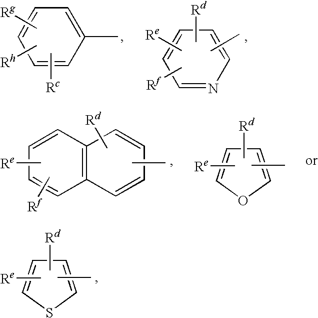

R^{a} and R^{β} are, independently of one another, hydrogen, (C₁-C₈)-alkyl, (C₃-C₈)-cycloalkyl, (C₃-C₆)-alkenyl, (C₃-C₆)-alkynyl,

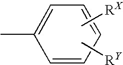

or (C₁-C₄)-alkoxy or

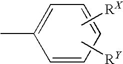

substituted by (C₁-C₄)-alkoxy, or
R^{α} and R^{β} are together a (C₄-C₆)-alkylene bridge or a (C₄-C₆)-alkylene bridge interrupted by oxygen, sulfur, SO, SO₂, NH or —N((C₁-C₄-)-alkyl)-,
R^{γ} is hydrogen or (C₁-C₄)-alkyl,
R^{a} and R^{b} are, independently of one another, hydrogen, halogen, cyano, nitro, trifluoromethyl, (C₁-C₄)-alkyl, (C₁-C₄)-alkoxy, (C₁-C₄)-alkylthio, (C₁-C₄)-alkylsulfinyl, (C₁-C₄)-alkylsulfonyl, —COOR^{j}, —CONR^{k}R^{m}, —CORⁿ, —SO₂NR^{k}R^{m} or —OSO₂—(C₁-C₄)-alkyl, or R^{a} and R^{b} are together a (C₃-C₄)-alkylene bridge, which can be substituted by halogen or (C₁-C₄)-alkyl, or a (C₃-C₄)-alkenylene bridge, which can be substituted by halogen or (C₁-C₄)-alkyl, or a C₄-alkadienylene bridge, which can be substituted by halogen or (C₁-C₄)-alkyl, and
R⁹ and R^{h} are, independently of one another, hydrogen, halogen, (C₁-C₄)-alkyl, trifluoromethyl, methoxy, methylthio or —COOR^{j}, in which
R^{c} is hydrogen, halogen, (C₁-C₄)-alkyl or methoxy,
R^{d} is hydrogen, halogen, nitro, (C₁-C₄)-alkyl, (C₁-C₄)-alkoxy, (C₁-C₄)-alkylthio, (C₁-C₄)-alkylsulfinyl, (C₁-C₄)-alkylsulfonyl, —COOR^{j} or —CONR^{k}R^{m},
R^{e} is hydrogen, halogen, (C₁-C₄)-alkyl, —COOR^{j}, trifluoromethyl or methoxy, or R^{d} and R^{e} are together a (C₃-C₄)-alkylene bridge,
R^{f} is hydrogen, halogen or (C₁-C₄)-alkyl,
R^{x} and R^{Y} are, independently of one another, hydrogen, halogen, (C₁-C₄)-alkyl, (C₁-C₄)-alkoxy, (C₁-C₄)-alkylthio, —COOR⁴, trifluoromethyl, nitro or cyano,
R^{j}, R^{k} and R^{m} are, independently of one another, hydrogen or (C₁-C₄)-alkyl,
R^{k} and R^{m} are together a (C₄-C₆)-alkylene bridge or a (C₄-C₆)-alkylene bridge interrupted by oxygen, NH or —N((C₁-C₄)-alkyl), and
Rⁿ is (C₁-C₄)-alkyl, phenyl or phenyl substituted by halogen, (C₁-C₄)-alkyl, methoxy, nitro or trifluoromethyl;
   preferably safeners of the formula (S-VIII) are
1-[4-(N-2-methoxybenzoylsulfamoyl)phenyl]-3-methylurea,
1-[4-(N-2-methoxybenzoylsulfamoyl)phenyl]-3,3-dimethylurea,
1-[4-(N-4,5-dimethylbenzoylsulfamoyl)phenyl]-3-methylurea,
1-[4-(N-naphthoylsulfamoyl)phenyl]-3,3-dimethylurea,
   inclusive of the stereoisomers and of the salts conventional in agriculture.

If not otherwise defined in detail, the following definitions are generally valid for the radicals in the formulae from (S-II) to (S-VIII).

The radicals alkyl, alkoxy, haloalkyl, haloalkoxy, alkylamino and alkylthio and also the corresponding unsaturated and/or substituted radicals can in each case be straight-chain or branched in the carbon backbone.

Alkyl radicals, also in the compound meanings, such as alkoxy, haloalkyl, and the like, preferably have from 1 to 4 carbon atoms and are, e.g., methyl, ethyl, n-propyl, isopropyl, n-butyl; isobutyl, t-butyl or 2-butyl. Alkenyl and alkynyl radicals have the meaning of the possible unsaturated radicals corresponding to the alkyl radicals; alkenyl is, e.g., allyl, 1-methylprop-2-en-1-yl, 2-methylprop-2-en-1-yl, but-2-en-1-yl, but-3-en-1-yl, 1-methylbut-3-en-1-yl and 1-methylbut-2-en-1-yl. Alkynyl is, e.g., propargyl, but-2-yn-1-yl, but-3-yn-1-yl, 1-methylbut-3-yn-1-yl. “(C₁-C₄)-Alkyl” is the shorthand for alkyl with 1 to 4 carbon atoms; This is correspondingly valid for other general radical definitions with ranges for the possible number of carbon atoms indicated in brackets.

Cycloalkyl is preferably a cyclic alkyl radical with from 3 to 8, preferably from 3 to 7, particularly preferably from 3 to 6 carbon atoms, for example cyclopropyl, cyclobutyl, cyclopentyl and cyclohexyl. Cycloalkenyl and cycloalkynyl are corresponding unsaturated compounds.

Halogen is fluorine, chlorine, bromine or iodine. Haloalkyl, haloalkenyl and haloalkynyl are alkyl, alkenyl or alkynyl partially or completed substituted by halogen, preferably by fluorine, chlorine and/or bromine, in particular by fluorine or chlorine, e.g. CF₃, CHF₂, CH₂F, CF₂CF₃, CH₂CHFCl, CCl₃, CHCl₂, CH₂CH₂Cl. Haloalkoxy is, e.g., OCF₃, OCHF₂, OCH₂F, OCF₂CF₃, OCH₂CF₃ and OCH₂CH₂Cl. This is correspondingly valid for other halogen-substituted radicals.

A hydrocarbon radical can be an aromatic or an aliphatic hydrocarbon radical, an aliphatic hydrocarbon radical generally being a saturated or unsaturated, straight-chain or branched, hydrocarbon radical, preferably with from 1 to 18, particularly preferably from 1 to 12, carbon atoms, e.g. alkyl, alkenyl or alkynyl.

Aliphatic hydrocarbon radical is preferably alkyl, alkenyl or alkynyl with up to 12 carbon atoms; This is correspondingly valid for an aliphatic hydrocarbon radical in a hydrocarbyloxy radical.

Aryl is generally a mono-, bi- or polycyclic aromatic system with preferably 6-20 carbon atoms, preferably from 6 to 14 carbon atoms, particularly preferably from 6 to 10 carbon atoms, e.g. phenyl, naphthyl, tetrahydronaphthyl, indenyl, indanyl, pentalenyl and fluorenyl, particularly preferably phenyl.

Heterocyclic ring, heterocyclic radical or heterocyclyl is a mono-, bi- or polycyclic ring system which is saturated, unsaturated and/or aromatic and comprises one or more, preferably from 1 to 4, heteroatoms, preferably from the group consisting of N, S and O.

Preference is given to saturated heterocycles with from 3 to 7 ring atoms and one or two heteroatoms from the group consisting of N, O and S, the chalcogens not being neighboring. Particular preference is given to monocyclic rings with from 3 to 7 ring atoms and a heteroatom from the group consisting of N, O and S, and also morpholine, dioxolane, piperazine, imidazoline and oxazolidine. Very particularly preferred saturated heterocycles are oxirane, pyrrolidone, morpholine and tetrahydrofuran.

Preference is also given to partially unsaturated heterocycles with from 5 to 7 ring atoms and one or two heteroatoms from the group consisting of N, O and S.

Particular preference is given to partially unsaturated heterocycles with from 5 to 6 ring atoms and one heteroatom from the group consisting of N, O and S. Very particularly preferred partially unsaturated heterocycles are pyrazoline, imidazoline and isoxazoline.

Preference is likewise given to heteroaryl, e.g. mono- or bicyclic aromatic heterocycles with from 5 to 6 ring atoms, which comprise from 1 to 4 heteroatoms from the group consisting of N, O and S, the chalcogens not being neighboring. Particular preference is given to monocyclic aromatic heterocycles with from 5 to 6 ring atoms comprising a heteroatom from the group consisting of N, O and S, and also pyrimidine, pyrazine, pyridazine, oxazole, thiazole, thiadiazole, oxadiazole, pyrazole, triazole and isoxazole. Preference is very particularly given to pyrazole, thiazole, triazole and furan.

Substituted radicals, such as substituted hydrocarbon radicals, e.g. substituted alkyl, alkenyl, alkynyl, aryl, such as phenyl and arylalkyl, such as benzyl, or substituted heterocyclyl are a substituted radical derived from the unsubstituted parent substance, the substituents preferably being one or more, preferably 1, 2 or 3, in the case of Cl and F also up to the maximum possible number, substituents from the group consisting of halogen, alkoxy, haloalkoxy, alkylthio, hydroxyl, amino, nitro, carboxyl, cyano, azido, alkoxycarbonyl, alkylcarbonyl, formyl, carbamoyl, mono- and dialkylaminocarbonyl, substituted amino, such as acylamino, mono- and dialkylamino, and alkylsulfinyl, haloalkylsulfinyl, alkylsulfonyl, haloalkylsulfonyl and, in the case of cyclic radicals, also alkyl and haloalkyl, and also unsaturated aliphatic substituents corresponding to the saturated hydrocarbon-comprising substituents mentioned, preferably alkenyl, alkynyl, alkenyloxy, alkynyloxy. Radicals with carbon atoms which are preferred are those with from 1 to 4 carbon atoms, in particular 1 or 2 carbon atoms. Preference is generally given to the substituents from the group consisting of halogen, e.g. fluorine or chlorine, (C₁-C₄)-alkyl, preferably methyl or ethyl, (C₁-C₄)-haloalkyl, preferably trifluoromethyl, (C₁-C₄)-alkoxy, preferably methoxy or ethoxy, (C₁-C₄)-haloalkoxy, nitro and cyano. Particular preference is given in this connection to the substituents methyl, methoxy and chlorine.

Mono- or disubstituted amino is a chemically stable radical from the group consisting of substituted amino radicals which are, for example, N-substituted by one or two identical or different radicals from the group consisting of alkyl, alkoxy, acyl and aryl; preferably monoalkylamino, dialkylamino, acylamino, arylamino, N-alkyl-N-arylamino and also N-heterocycles. In this connection, alkyl radicals with from 1 to 4 carbon atoms are preferred. Aryl is in this connection preferably phenyl. Substituted aryl is in this connection preferably substituted phenyl. The definition mentioned further below for acyl is valid in this connection, preferably (C₁-C₄)-alkanoyl. This is correspondingly valid for substituted hydroxylamino or hydrazino. Phenyl which is, if appropriate, substituted is preferably phenyl which is unsubstituted or substituted one or more times, preferably up to three times, by halogen, such as Cl and F, also up to five times by identical or different radicals from the group consisting of halogen, (C₁-C₄)-alkyl, (C₁-C₄)-alkoxy, (C₁-C₄)-haloalkyl, (C₁-C₄)-haloalkoxy and nitro, e.g. o-, m- and p-tolyl, dimethylphenyl, 2-, 3- and 4-chlorophenyl, 2-, 3- and 4-trifluorophenyl and 2-, 3- and 4-trichlorophenyl, 2,4-, 3,5-, 2,5- and 2,3-dichlorophenyl, o-, m- and p-methoxyphenyl.

An acyl radical is the radical of an organic acid with preferably up to 6 carbon atoms, e.g. the radical of a carboxylic acid and radicals of acids derived therefrom, such as thiocarboxylic acid, if appropriate N-substituted iminocarboxylic acids, or the radical of carbonic acid monoesters, if appropriate N-substituted carbamic acids, sulfonic acids, sulfinic acids, phosphonic acids, phosphinic acids. Acyl is, for example, formyl, alkylcarbonyl, such as (C₁-C₄)-alkylcarbonyl, phenylcarbonyl, it being possible for the phenyl ring to be substituted, e.g. as indicated above for phenyl, or alkyloxycarbonyl, phenyloxycarbonyl, benzyloxycarbonyl, alkylsulfonyl, alkylsulfinyl or N-alkyl-1-iminoalkyl.

The formulae (S-II) to (S-VIII) also comprise all stereoisomers which exhibit the same topological linking of the atoms, and their mixtures thereof. Such compounds comprise one or more asymmetric carbon atoms or also double bonds which are not indicated separately in the general formulae. The possible stereoisomers defined by their specific spatial form, such as enantiomers, diastereomers, Z- and E-isomers, can be obtained according to conventional methods from mixtures of the stereoisomers or can also be prepared by stereoselective reactions in combination with the use of stereochemically pure starting materials.

The compounds of the formula (S-II) are known, e.g., from EP-A-0 333 131 (ZA 89/1960), EP-A-0 269 806 (U.S. Pat. No. 4,891,057), EP-A-0 346 620 (AU-A-89/34951), EP-A-0 174 562, EP-A-0 346 620 (WO-A-91/08202), WO-A-91/07874 or WO-A-95/07897 (ZA 94/7120) and the literature cited therein or can be prepared according to or analogously to the processes described therein. The compounds of the formula (S-III) are known from EP-A-0 086 750, EP-A-094 349 (U.S. Pat. No. 4,902,340), EP-A-0 191 736 (U.S. Pat. No. 4,881,966) and EP-A-0 492 366 and literature cited therein or can be prepared according to or analogously to the processes described therein. Some compounds are furthermore described in EP-A-0 582 198 and WO-A-02/34048. The compounds of the formula (S-IV) are known from numerous patent applications, for example U.S. Pat. No. 4,021,224 and U.S. Pat. No. 4,021,229. Compounds of the subgroup b) are furthermore known from CN-A-87/102789, EP-A-365 484 and also from “The Pesticide Manual”, 11^{th} to 13^{th} edition, British Crop Protection Council and the Royal Society of Chemistry (1997). The compounds of the subgroup c) are described in WO-A-97/45016 and those of the subgroup d) are described in WO-A-99/16744 (in particular in EP-A-365 484). The documents cited comprise detailed instructions for preparation processes and starting materials and mention preferred compounds. These publications are expressly referred to herewith; they are incorporated in the present description by reference.

The safeners of the preceding groups a) to e) reduce or prevent phytotoxic effects which may occur on using the herbicidal compositions according to the invention in useful crop plants, without the effectiveness of the herbicides against harmful plants being reduced. Through this, the field of use of the herbicides can be greatly enlarged and the use of herbicides which hitherto could only be used to a limited extent or insufficiently successfully, i.e. of combinations which, without safeners, resulted, in low dosages with a narrow spectrum of action, in unsatisfactory control of the harmful plants, is possible in particular by the use of safeners.

Particular preference is given, as safeners in the formulations according to the invention, to, inter alia: 4-dichloroacetyl-1-oxa-4-azaspiro[4.5]decane (AD-67), 1-dichloroacetylhexahydro-3,3,8α-trimethylpyrrolo[1,2-a]pyrimidin-6(2H)-one (dicyclonone, BAS-145138), 4-dichloroacetyl-3,4-dihydro-3-methyl-2H-1,4-benzoxazine (benoxacor), cloquintocet, 1-methylhexyl 5-chloroquinolin-8-oxyacetate (cloquintocet-mexyl), α-(cyanomethoxyimino)phenylacetonitrile (cyometrinil), 2,2-dichloro-N-(2-oxo-2-(2-propenylamino)ethyl)-N-(2-propenyl)acetamide (DKA-24), 2,2-dichloro-N,N-di(2-propenyl)acetamide (dichloromid), N-(4-methylphenyl)-N′-(1-methyl-1-phenylethyl)urea (dymron), 4,6-dichloro-2-phenylpyrimidine (fenclorim), ethyl 1-(2,4-dichlorophenyl)-5-trichloromethyl-1H-1,2,4-triazole-3-carboxylate (fenchlorazole-ethyl), phenylmethyl 2-chloro-4-trifluoromethylthiazole-5-carboxylate (flurazole), 4-chloro-N-(1,3-dioxolan-2-ylmethoxy)-α-trifluoroacetophenone oxime (fluxofenim), 3-dichloroacetyl-5-(2-furanyl)-2,2-dimethyloxazolidine (furilazole, MON-13900), ethyl 4,5-dihydro-5,5-diphenyl-3-isoxazolecarboxylate (isoxadifen-ethyl), diethyl 1-(2,4-dichlorophenyl)-4,5-dihydro-5-methyl-1H-pyrazole-3,5-dicarboxylate (mefenpyr-diethyl), 2-dichloromethyl-2-methyl-1,3-dioxolane (MG-191), 1,8-naphthalic anhydride, α-(1,3-dioxolan-2-ylmethoxyimino)phenylacetonitrile (oxabetrinil), 2,2-dichloro-N-(1,3-dioxolan-2-ylmethyl)-N-(2-propenyl)acetamide (PPG-1292), 3-dichloroacetyl-2,2-dimethyloxazolidine (R-28725), 3-dichloroacetyl-2,2,5-trimethyloxazolidine (R-29148), methyl 1-(2-chlorophenyl)-5-phenyl-1H-pyrazole-3-carboxylate, 4-cyclopropylaminocarbonyl-N-(2-methoxybenzoyl)benzenesulfonamide (cyprosulfamide), 4-isopropylaminocarbonyl-N-(2-methoxybenzoyl)benzenesulfonamide and N-(2-methoxybenzoyl)-4-[(methylaminocarbonyl)amino]benzenesulfonamide.

The safeners present in the microemulsion concentrates according to the invention are very particularly preferably mefenpyr-diethyl, cloquintocet-mexyl, isoxadifen-ethyl, 4-cyclopropylaminocarbonyl-N-(2-methoxybenzoyl)benzenesulfonamide (cyprosulfamide), 4-isopropylaminocarbonyl-N-(2-methoxybenzoyl)benzenesulfonamide or fenchlorazole-ethyl; very particularly preferred in particular are mefenpyr-diethyl, cloquintocet-mexyl or isoxadifen-ethyl.

A particular embodiment of the microemulsion concentrates according to the invention is the joint formulation of herbicides and safeners as agrochemical active substances.

The herbicide/safener mixtures present in the microemulsion concentrates according to the invention are preferably combinations of the following compounds with one another:

a) compounds which are effective as ACCase inhibitors, such as alloxydim, butroxydim, clethodim, clodinafop-propargyl, cycloxydim, cyhalofop-butyl, diclofop-methyl, fenoxaprop, fenoxaprop-ethyl, fenoxaprop-P, fenoxaprop-P-ethyl, fluazifop, fluazifop-P-butyl, fluazifop-butyl, haloxyfop, haloxyfop-P, haloxyfop-etotyl, haloxyfop-P-methyl, metamifop, profoxydim, propaquizafop, quizalofop-P-tefuryl, quizalofop-P-ethyl, sethoxydim, tepraloxydim, tralkoxydim and isoxapyrifop,

b) compounds which are effective as p-hydroxyphenyl pyruvate dioxygenase (HPPD) inhibitors, such as benzobicyclon, benzofenap, isoxaflutole and the diketonitriles thereof, mesotrione, pyrazolynate, pyrazoxyfen, sulcotrione and isoxachlortole,

c) compounds of the different active substance groups, such as atrazine, acetochior, aclonifen, alachlor, amidochlor, amidosulfuron, azimsulfuron, bentazon, bensulfuron(-methyl), bromoxynil (octanoate/heptanoate), butachlor, bispyribac, chlorsulfuron, chlorimuron, clomazone, clopyralid, cinosulfuron, cyclosulfamuron, 2,4-D-ester, 2,4-DB-ester, 2,4-DP-ester, CMPP-ester, MCPA-ester, MCPB, EPIC, desmedipham, diflufenican, dicamba, ethoxysulfuron, ethofumesate, flazasulfuron, florasulam, flucarbazone, flumetsulam, flufenacet, fluoroglycofen, fluoroxypyr, flupyrsulfuron, foramsulfuron, flumioxazin, flumiclorac, fomesafen, glufosinate, glyphosate, imazapyr, imazosulfuron, iodosulfuron, iodosulfuron-methyl, ioxynil (octanoate), lactofen, halosulfuron, imazamox, imazapic, imazethapyr, imazaquin, metosulam, mesosulfuron(-methyl), (S-)metolachlor, metsulfuron-methyl, metamitron, nicosulfuron, oxyfluorfen, pendimethalin, phenmedipham, picloram, pinoxaden, primisulfuron-methyl, prosulfuron, propanil, propoxycarbazone, pyrazosulfuron(-methyl), rimsulfuron, sulfentrazone, sulfosulfuron, sulfometuron, terbuthylazine, thifensulfuron, triasulfuron, tribenuron, triclopyr, triflusulfuron-methyl, trifluralin, tritosulfuron, topramezone, oxazinone, oxadiargyl, metribuzin, and the salts thereof, e.g. the sodium salts.

d) compounds which are effective as safeners, such as AD 67 (4-(dichloroacetyl)-1-oxa-4-azaspiro[4.5]decane), benoxacor, CL 304,415 (4-carboxymethylchroman-4-carboxylic acid), cloquintocet, cloquintocet-mexyl, cyprosulfamide, dichlormid, dicyclonone, DKA-24 (N1,N2-diallyl-N2-dichloroacetylglycinamide), fenchlorazole, fenchlorazole-ethyl, fenclorim, flurazole, fluxofenim, furilazole, isoxadifen-ethyl, mefenpyr-diethyl, MG 191 (2-dichloromethyl-2-methyl-1,3-dioxolane), naphthalic anhydride (naphthalene-1,8-dicarboxylic anhydride), oxabetrinil and TI-35 (1-dichloroacetylazepane).

In an additional embodiment, different herbicides can, e.g., be combined with one another, e.g. fenoxaprop-P-ethyl+ioxynil octanoate, diclofop-methyl+bromoxynil octanoate, CMPP+bromoxynil octanoate, MCPA+ioxynil octanoate, bromoxynil octanoate+bromoxynil heptanoate, bromoxynil octanoate+brornoxynil heptanoate+MCPA, bromoxynil octanoate+bromoxynil heptanoate+2,4-D, phenmedipham+desmedipham, phenmedipham+desmedipham+ethofumesate, metamitron+ethofumesate, phenmedipham+ethofumesate+metamitron, fenoxaprop-P-ethyl+iodosulfuron-methyl-sodium, fenoxaprop-P-ethyl+diclofop-methyl, fenoxaprop-P-ethyl

+iodosulfuron-methyl-sodium+diclofop-methyl.

The following combinations are particularly preferred: foramsulfuron+iodosulfuron-methyl-sodium+isoxadifen-ethyl, iodosulfuron-methyl-sodium+isoxadifen-ethyl, foramsulfuron+isoxadifen-ethyl, fenoxaprop-P-ethyl+ethoxysulfuron+isoxadifen-ethyl, ethoxysulfuron+isoxadifen-ethyl, fenoxaprop-P-ethyl+isoxadifen-ethyl, iodosulfuron-methyl-sodium+mesosulfuron-methyl+mefenpyr-diethyl, mesosulfuron-methyl+mefenpyr-diethyl, iodosulfuron-methyl-sodium+mefenpyr-diethyl, fenoxaprop-P-ethyl+mefenpyr-diethyl, fenoxaprop-P-ethyl+diclofop-methyl+mefenpyr-diethyl, diclofop-methyl+mefenpyr-diethyl, diclofop-methyl+sethoxydim+mefenpyr-diethyl, sethoxydim+mefenpyr-diethyl, fenoxaprop-P-ethyl+isoproturon+mefenpyr-diethyl, isoproturon+mefenpyr-diethyl, clodinafop-propargyl+cloquintocet-mexyl, fenoxaprop-ethyl+fenchlorazole-ethyl, fenoxaprop-P-ethyl+fenchlorazole-ethyl, flucarbazone+cyprosulfamide, foramsulfuron+cyprosulfamide, iodosulfuron(-methyl)+cyprosulfamide, metosulam+cyprosulfamide, metsulfuron(-methyl)+cyprosulfamide, nicosulfuron+cyprosulfamide, primisulfuron(-methyl)+cyprosulfamide, prosulfuron+cyprosulfamide, thifensulfuron+cyprosulfamide, tribenuron+cyprosulfamide, cloransulam-methyl+cyprosulfamide, chlorimuron+cyprosulfamide, ethoxysulfuron+cyprosulfamide, flazasulfuron+cyprosulfamide, florasulam+cyprosulfamide, flumetsulam+cyprosulfamide, halosulfuron+cyprosulfamide, imazamox+cyprosulfamide, imazapic+cyprosulfamide, imazapyr+cyprosulfamide, imazethapyr+cyprosulfamide, mesosulfuron+cyprosulfamide, propoxycarbazone+cyprosulfamide, sulfosulfuron+cyprosulfamide, amidosulfuron+cyprosulfamide, chlorsulfuron+cyprosulfamide, imazaquin+cyprosulfamide, triasulfuron+cyprosulfamide, sulfometuron+cyprosulfamide, cyclosulfamuron+cyprosulfamide, flupyrsulfuron+cyprosulfamide, pyrazosulfuron+cyprosulfamide, azimsulfuron+cyprosulfamide, bensulfuron+cyprosulfamide, bispyribac+cyprosulfamide, rimsulfuron+cyprosulfamide, tritosulfuron+cyprosulfamide, sulcotrione+cyprosulfamide, clomazone+cyprosulfamide, mesotrione+cyprosulfamide, topramezone+cyprosulfamide, metribuzin+cyprosulfamide, bentazon+cyprosulfamide, bromoxynil+cyprosulfamide, propanil+cyprosulfamide, atrazine+cyprosulfamide, terbuthylazine+cyprosulfamide, EPIC+cyprosulfamide, tepraloxydim+cyprosulfamide, clethodim+cyprosulfamide, alloyxdim+cyprosulfamide, sethoxydim+cyprosulfamide, tralkoxydim+cyprosulfamide, clodinafop-propargyl+cyprosulfamide, cyhalofop-butyl+cyprosulfamide, diclofop-methyl+cyprosulfamide, fenoxaprop-P-ethyl+cyprosulfamide, fluazifop-P-butyl+cyprosulfamide, haloxyfop-methyl+cyprosulfamide, haloxyfop-ethyl+cyprosulfamide, haloxyfop-R-methyl+cyprosulfamide, haloxyfop-ethoxyethyl+cyprosulfamide, propaquizafop+cyprosulfamide, quizalofop-P-tefuryl+cyprosulfamide, quizalofop-P-ethyl+cyprosulfamide, acetochlor+cyprosulfamide, S-metolachlor+cyprosulfamide, flumioxazin+cyprosulfamide, flumiclorac+cyprosulfamide, fomesafen+cyprosulfamide, sulfentrazone+cyprosulfamide, dicamba+cyprosulfamide, MCPA+cyprosulfamide, MCPB+cyprosulfamide, 2,4-D+cyprosulfamide, clopyralid+cyprosulfamide, fluoroxypyr+cyprosulfamide, picloram+cyprosulfamide, triclopyr+cyprosulfamide, glufosinate+cyprosulfamide, glyphosate+cyprosulfamide and pendimethalin+cyprosulfamide.

The safener:herbicide ratio by weight can vary within wide limits and preferably ranges from 1:100 to 100:1, in particular from 1:100 to 50:1, very particularly preferably 1:10 to 10:1. The optimum amounts of herbicide(s) and safener(s) in each case usually depend on the type of herbicide and/or on the safener used and also on the species of crop to be treated.

Aromatic and nonaromatic alcohols in particular are suitable as alcoholic solvents with at least 5 carbon atoms (component b).

Aromatic alcohols comprise at least one aromatic and/or nonheteroaromatic group and at least one OH functional group. Preferred aromatic alcohols are those which are derived from benzene, in particular monofunctional alcohols derived from benzene, e.g. those of the general formula (I)

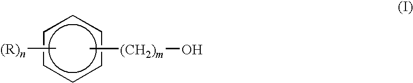

in which
R is a (C₁-C₁₀)-alkyl radical, e.g. methyl, ethyl, propyl or butyl, or H,
n is an integer from 0 to 5, preferably 0, 1 or 2, particularly preferably 0,
m is an integer from 0 to 10, preferably from 0 to 5, in particular from 1 to 5, especially 1 or 2.

Particular preference is given, as component (b), to compounds of the formula (I) in which n=0 and m is an integer from 1 to 5; very particular preference is given here to benzyl alcohol.

Nonaromatic alcohols are cyclic, aliphatic, saturated or unsaturated or branched or unbranched alcohols. Examples of monohydric alcohols with 5 to 25 carbon atoms are n-pentanol, isopentanol or neopentanol, n-hexanol, isohexanol, s-hexanol, n-heptanol, isoheptanol, s-heptanol, n-octanol, isooctanol, s-octanol, n-decanol, isodecanol, s-decanol, n-undecanol, isoundecanol, s-undecanol, n-dodecanol, isododecanol, s-dodecanol, n-tridecyl alcohol, isotridecyl alcohol, s-tridecyl alcohol, e.g. cyclohexanol. Examples of polyhydric alcohols are neopentyl glycol. Polyglycols, commercially available, e.g., as Exxal® series (ExxonMobil), Agrisynth® PA (ISP), Arcosolv® series (Lyondell Chemical) or Nacol® 6-98 (DEA), are also suitable.

Preference is given to alcohols with at least 5 carbon atoms, particular preference is given to alcohols with 5 to 25 carbon atoms and very particular preference is given to alcohols with 6 to 20 carbon atoms. The alcohols can be primary, secondary or tertiary alcohols. In particular, benzyl alcohol, n-hexanol, isohexanol, s-hexanol, n-heptanol, isoheptanol, s-heptanol, n-octanol, isooctanol and s-octanol are preferred as alcoholic solvents (component b).

Suitable nonalcoholic solvents (component c) are, for example, hydrocarbons or polar solvents, such as carboxylic acid derivatives, phosphoric acid esters, ethers, ketones or sulfoxides, such as dimethyl sulfoxide, in which water can occur at best as impurity of an inert material in contents of at most S 2% by weight, in particular ≦1% by weight.

Examples of hydrocarbons (see, e.g., Römpp Lexikon Chemie, 10^{th} edition, Volume 3, page 2202 (1997), Georg Thieme Verlag, Stuttgart/New York) are preferably those which are liquid under standard conditions. The hydrocarbons can be acyclic (aliphatic) hydrocarbons or cyclic hydrocarbons, e.g. aromatic, alicyclic (cycloaliphatic) or heterocyclic hydrocarbons.

Examples of hydrocarbons as component (c) are:

1) aromatic hydrocarbons, e.g.
aromatic compounds monosubstituted or polysubstituted by alkyl groups (e.g., monosubstituted, disubstituted or trisubstituted by (C₁-C₁₀)-alkyl groups), e.g. benzenes, such as toluene, xylene, mesitylene, ethylbenzene, or
hydrocarbons with condensed aromatic ring systems, such as naphthalenes, e.g., 1-methylnaphthalene, 2-methylnaphthalene or dimethylnaphthalene, or other condensed aromatic hydrocarbons, such as indane or tetralin,
   2) cycloaliphatic hydrocarbons, e.g.
saturated or unsaturated cycloaliphatic compounds which are, if appropriate, monosubstituted or polysubstituted by alkyl groups (e.g., monosubstituted, disubstituted or trisubstituted by (C₁-C₁₀)-alkyl groups), such as cycloalkanes, cycloalkenes or cycloalkynes, e.g. cyclohexane or methylcyclopentane,
   3) heterocyclic hydrocarbons, e.g. dioxane, furan,
   4) aliphatic hydrocarbons, e.g.
linear or branched, saturated or unsaturated aliphatic compounds, preferably C₅-C₁₆-aliphatic compounds, e.g. alkanes, alkenes or alkynes, such as pentane, hexane, octane, 2-methylbutane or 2,2,4-trimethylpentane.

Mixtures of one or more aromatic hydrocarbons and/or of one or more cycloaliphatic hydrocarbons and/or of one or more aliphatic hydrocarbons may also be present. Examples are mixtures of several aliphatic hydrocarbons, e.g. commercially available solvents of the Exxsol® D series, Isopar® series or Bayol® series, e.g. Bayol® 85 (Exxon Mobil Chemicals), or of the Isane® IP series or Hydroseal® G series (Total Fina Elf), or mixtures of aromatic and aliphatic hydrocarbons, e.g. commercially available solvents of the Solvesso® series, e.g. Solvesso® 100, Solvesso® 150, Solvesso® 200 or Solvesso® 200 ND (Exxon Mobil Chemicals), of the Solvarex®/Solvaro® series (Total Fina Elf) or of the Caromax® series, e.g. Caromax® 28 (Petrochem Carless).

Examples of polar solvents are polar aprotic solvents, such as carboxylates, e.g. the full ethers and full esters of (C₁-C₆)-alkanoic acids which can be mono-, di- or polyfunctional, e.g. the ethers and esters with (C₁-C₂₀)-alkyl alcohols, such as ketones, phosphoric acid esters, such as tri(butoxyethyl) phosphate, triethyl phosphate, amides, nitriles or sulfones, e.g. diisobutyl adipate, Rhodiasolv® RPDE (Rhodia), cyclohexanone, Jeffsol® PC (Huntsman), γ-butyrolactone, N-methylpyrrolidone, N-octylpyrrolidone, sulfoxides, such as dimethyl sulfoxide, acetonitrile, tributyl phosphate or Hostarex® PO series (Clariant), or polar protic solvents, such as aliphatic and cycloaliphatic alcohols, amines or carboxylic acids. The alcohols, amines or carboxylic acids preferably exhibit from 1 to 18 carbon atoms and can be linear, branched or cyclic, saturated or unsaturated, can, if appropriate, comprise heteroatoms and can be mono- or polyfunctionalized. Examples of amines are diethylamine, hexylamine or aniline. Examples of carboxylic acids are monocarboxylic acids or partially esterified di- or polycarboxylic acids, e.g. adipic acid and adipic acid monoesters.

Examples of carboxylic acid derivatives are, e.g., the full esters or amides of carboxylic acids. Possible carboxylic acid derivatives are, e.g., the esters and amides of monocarboxylic acids, dicarboxylic acids or polycarboxylic acids, such as tricarboxylic acids, tetracarboxylic acids or carboxylic acids of higher functionality, preferably with 2-26 carbon atoms.

Preferred carboxylates are the esters with (C₁-C₂₀)-alcohols (e.g., methanol, ethanol, propanol or butanol); in particular with fatty acid esters, the glycerol and glycol esters are also preferred. Internal esters, such as lactones, are also possible as carboxylates.

Examples of monocarboxylates are the esters of aliphatic and aromatic monocarboxylic acids, e.g. aliphatic (C₁-C₈)-monocarboxylates, such as formates, acetates and propionates, or aliphatic fatty acid esters, such as (C₁₀-C₂₂)-fatty acid esters, e.g. of natural origin, such as are present in natural oils or vegetable oils, or of synthetic origin, or aromatic (C₇-C₂₂)-monocarboxylates, such as benzoates or phenylacetates.

Examples of fatty acid esters are, e.g., those of natural origin, e.g. natural oils, such as animal oils or plant oils, or of synthetic origin, e.g. Edenor® MESU or Agnique® ME series (Cognis), of the Salim® ME series (Salim), of the Stepan® C series (Stepan) or of the Witconol® 23 series (Witco). Esters of (C₁₀-C₂₂)-fatty acids, preferably (C₁₂-C₂₀)-fatty acids, are preferred as fatty acid esters. The (C₁₀-C₂₂)-fatty acid esters are, for example, esters of unsaturated or saturated (C₁₀-C₂₂)-fatty acids, in particular with an even number of carbon atoms, e.g. erucic acid, lauric acid, palmitic acid and in particular C₁₈-fatty acids, such as stearic acid, oleic acid, linoleic acid or linolenic acid.

Examples of fatty acid esters, such as (C₁₀-C₂₂)-fatty acid esters, are glycerol and glycol esters of fatty acids, such as (C₁₀-C₂₂)-fatty acids, or the transesterification products thereof, e.g. fatty acid alkyl esters, such as (C₁-C₂₀)-alkyl (C₁₀-C₂₂)-fatty acid esters, such as e.g., can be obtained by transesterification of the abovementioned glycerol or glycol fatty acid esters, such as (C₁₀-C₂₂)-fatty acid esters, with (C₁-C₂₀)-alcohols (e.g., methanol, ethanol, propanol or butanol). The transesterification can be carried out according to known methods, such as, e.g., are described in Römpp Chemie Lexikon, 9^{th} edition, Volume 2, page 1343, Thieme Verlag, Stuttgart.

Preferred fatty acid esters are, e.g., oils from oleiferous plant species, such as soybean oil, rapeseed oil, corn oil, sunflower oil, cottonseed oil, linseed oil, coconut oil, palm oil, thistle oil, walnut oil, peanut oil, olive oil or castor oil, in particular rapeseed oil, the term “vegetable oils” also being understood to include the transesterification products thereof, e.g. alkyl esters, such as rapeseed oil methyl ester or rapeseed oil ethyl ester.

Examples of dicarboxylates and polycarboxylates are the full esters of oxalic, malonic, succinic, glutaric, adipic, pimellic, sebacic, azelaic, suberic, maleic, phthalic, terephthalic, mellitic, trimellitic and polymaleic acid, in particular the (C₁-C₁₀)-alkyl esters, such as the methyl esters, ethyl esters, propyl esters, such as n-propyl esters or isopropyl esters, butyl esters, such as n-butyl esters, isobutyl esters, sec-butyl esters or tert-butyl esters.

Possible carboxamides are also N,N-di((C₁-C₂₀)-alkyl)-(C₁-C₂₆)-carboxamides, e.g. N,N-dimethyl-(C₁-C₂₆)-carboxamides, such as N,N-dimethylformamide or N,N-dimethylacetamide, or internal amides such as lactams, e.g. pyrrolidones, such as N-substituted (C₁-C₁₂)-alkylpyrrolidones, such as N-methylpyrrolidone, N-butylpyrrolidone, N-octylpyrrolidone, N-dodecylpyrrolidone and N-cyclohexylpyrrolidone.

Suitable phosphoric acid esters are, for example, triesters of phosphoric acid with alcohols, the alcohols preferably being chosen from the group consisting of,
1) monohydric alkanols with 1 to 22 carbon atoms, e.g. n-pentanol, isopentanol, neopentanol, n-hexanol, n-octanol, 2-ethylhexanol,
2) diols or polyols, such as ethylene glycol, propylene glycol or glycerol,
3) aryl, alkylaryl, poly(alkyl)aryl and poly(arylalkyl)aryl alcohols, for example phenol and/or cresol, octylphenol, nonylphenol, triisobutylphenol, tristyryiphenol,
4) alkoxylated alcohols which are obtained by reaction of the alcohols mentioned above under 1), 2) or 3) with alkylene oxides, preferably (C₁-C₄)-alkylene oxides.

Preferred phosphoric acid esters are triesters of orthophosphoric acid, in particular alkoxylated triesters of orthophosphoric acid, such as tri(butoxyethyl)phosphate.

Possible ketones are, for example, aromatic, cycloaliphatic or aliphatic ketones, such as acetophenone, benzophenone, isophorone, cyclohexanone and methyl ethyl ketone, ethyl butyl ketone, diethyl ketone, dibutyl ketone.

Possible ethers are, for example, aromatic, cycloaliphatic or aliphatic ethers, such as anisole, tetrahydrofuran, oxirane, dibutyl ether, dipentyl ether, butyl hexyl ether, methyl tert-butyl ether.

Preferred nonalcoholic solvents (component c) are aromatic hydrocarbons, such as (C₁-C₆)-alkylbenzenes, e.g. toluene or xylene, (C₁-C₆)-alkylnaphthalenes and mixtures of aromatic compounds, such as the Solvesso® series from Exxon, ketones, such as acetophenone, isophorone, cyclohexanone and methyl ethyl ketone, N-substituted (C₁-C₁₂)-alkylpyrrolidones, such as N-methylpyrrolidone, N-butylpyrrolidone, N-octylpyrrolidone, N-dodecylpyrrolidone and. N-cyclohexylpyrrolidone, cyclic aliphatic hydrocarbons, such as decalin and cyclohexane, acid amides, such as dimethylformamide, dimethylsulfoxide, lactones, such as γ-butyrolactone, di- or polycarboxylates, such as (C₁-C₁₂)-alkyl phthalates, adipates, e.g. diisopropyl adipate, dimethyl adipate and diisobutyl adipate, phosphoric acid esters, such as trialkenyl phosphates, e.g. tri(butoxyethyl) phosphate or triethyl phosphate, and also fatty acid esters. Particularly preferred nonalcoholic solvents. (component c) are aromatic solvents, such as Solvesso® 100, Solvesso® 150, Solvesso® 200 or Solvesso® 200 ND, xylene, triethyl phosphate, rapeseed oil methyl ester (e.g., Edenor® MESU or Agnique® ME series) or rapeseed oil ethyl ester, N-octylpyrrolidone and also N-methylpyrrolidone.

Suitable as anionic surfactants (component d) are, for example, sulfates, sutfonates, sulfosuccinates, phosphates and phosphonates of hydrocarbons which can optionally comprise alkylene oxide units. The sulfates, sulfonates, phosphates and phosphonates can be present in the form of the acids or of salts. Preference is given to anionic surfactants (d) of the following formula (II):

R-Q (II)

in which
Q is —O—SO₃M, —SO₃M, —O—PO₃HM or PO₃HM,
   in which M is the same is H or is a cation, in particular a metal cation, such as an alkali metal ion or an alkaline earth metal ion, or an ammonium ion,
R is an unsubstituted or substituted (C₁-C₃₀)-hydrocarbon radical, such as a (C₁-C₂₀)-alkyl radical or (C₆-C₂₄)-aryl radical, which can optionally be bonded via alkylene oxide units, or R is an alkylene oxide unit.

The term “alkylene oxide units” is to be understood as meaning in particular units of (C₂-C₁₀)-alkylene oxides, such as ethylene oxide, propylene oxide or butylene oxide, it being possible for the units inside the surfactant to be identical or different from one another and in this connection to be arranged in randomly mixed or blockwise fashion.

R is preferably a (C₁-C₂₀)-alkyl radical (e.g., methyl, ethyl, propyl, butyl) or a (C₆-C₂₄)-aryl radical (e.g., phenyl, biphenyl, naphthyl) which can optionally carry one or more radicals, such as (C₁-C₂₀)-hydrocarbon radicals, e.g. from the group consisting of (C₁-C₂₀)-alkyl (e.g., linear or branched (C₁-C₂₀)-alkyl, such as sec-butyl or dodecyl), which can carry one or more radicals, such as (C₆-C₂₀)-aryl radicals (e.g., phenyl, biphenyl, naphthyl), and (C₆-C₂₀)-aryl (e.g., phenyl, biphenyl or naphthyl), which can optionally carry one or more radicals, such as (C₁-C₁₀)-alkyl (e.g., methyl, ethyl, propyl, butyl), or

R is a radical R²O(AO)_{w}, in which w is an integer from 1 to 100, preferably from 2 to 50, in particular from 2 to 10, and AO is an alkylene oxide unit, e.g. (EO)_{X}(PO)_{Y}(BO)_{Z}, in which EO is an ethylene oxide unit, PO is a propylene oxide unit, BO is a butylene oxide unit, x is an integer from 0 to 100, y is an integer from 0 to 100, z is an integer from 0 to 100 and the sum x+y+z is at least 1, and the alkylene oxide unit, e.g. (EO)_{X}(PO)_{Y}(BO)_{Z}, can be constructed in randomly mixed or blockwise fashion, and R² is H, a (C₁-C₂₀)-alkyl radical (e.g., methyl, ethyl, propyl, butyl) or a (C₆-C₂₄)-aryl radical (e.g., phenyl, biphenyl, naphthyl) which can optionally carry one or more radicals, such as (C₁-C₂₀)-hydrocarbon radicals, e.g. from the group consisting of (C₁-C₂₀)-alkyl (e.g., linear or branched (C₁-C₂₀)-alkyl, such as sec-butyl or dodecyl), which can carry one or more radicals, such as (C₁-C₂₀)-hydrocarbon radicals, such as (C₆-C₂₀)-aryl radicals (e.g., phenyl, biphenyl, naphthyl), and (C₆-C₂₀)-aryl (e.g., phenyl, biphenyl, naphthyl), which can optionally carry one or more radicals, such as (C₁-C₁₀)-alkyl (e.g., methyl, ethyl, propyl, butyl), or R² is —O—SO₃M, —SO₃M, —O—PO₃HM, H or PO₃HM, preferably PO₃HM, in which M is the same as H or is a cation, in particular a metal cation, such as an alkali metal ion or alkaline earth metal ion, or an ammonium ion.

Particularly preferred anionic surfactants (d) are dialkyl sulfosuccinates, such as, e.g., di(2-ethylhexyl) sodium sulfosuccinate (e.g., Triton® GR 7 ME from Union Carbide), alkylarylsulfonates, such as dodecylbenzenesulfonates, e.g. alkaline earth metal dodecylbenzenesulfonates, such as calcium dodecylbenzenesulfonates (e.g. Phenylsulfonate® Ca 100, synonym Calsogen® AR 100 ND, Phenylsulfonate® Ca 70 from Clariant), alkylaryl polyglycol ether sulfates and sulfonates, in particular arylalkylaryl polyglycol ether sulfates, such as tristyrylphenol polyglycol ether sulfates, in particular the alkali metal or ammonium or triethanolamine salts (e.g. Soprophor® series from Rhodia), alkyl ether sulfates and the salts thereof (e.g. such as Genapol® LRO from Clariant), alkyl sulfates and alkylsulfonates (e.g. such as the Hostapur® series from Clariant), alkyl polyglycol ether phosphates, in particular the alkali metal salts (e.g. the Rhodafac® series from Rhodia), alkylaryl polyglycol ether phosphates and phosphonates, in particular in the form of the alkali metal salts. The salts are in general preferably metal salts, such as alkali metal or alkaline earth metal salts, or ammonium or trialkylamine salts.

Suitable as nonionic surfactants (component e) are, for example, alkoxylates, e.g. ethoxylates, propoxylates or butoxylates, and the combinations thereof. The term “alkoxylates” is to be understood as meaning compounds comprising alkylene oxide units, in particular units of (C₂-C₁₀)-alkylene oxides, such as ethylene oxide, propylene oxide or butylene oxide, it being possible for the units inside the surfactant to be identical or different from one another and in this connection to be arranged in randomly mixed or blockwise fashion. Examples of alkoxylates as component (e) are compounds of the following formula (III):

R¹-(AO)_{w}—R² (III),

in which
R¹ is chosen from the group consisting of H, HO, (C₁-C₃₀)-alkyl, which can be linear or branched (e.g., methyl, ethyl, propyl, butyl, pentyl, hexyl), (C₁-C₃₀)-alkoxy, preferably (C₁-C₁₀)-alkoxy, which can be linear or branched (e.g., methoxy, ethoxy, propoxy, butoxy, pentoxy, hexoxy), (C₆-C₂₄)-aryl (e.g. phenyl), which can optionally carry one or more radicals, such as (C₁-C₃₀)-arylalkyl (e.g. styrylphenyl) or (C₁-C₃₀)-alkyl, in which the alkyl groups can be linear or branched (e.g. butyl or dodecyl), (C₆-C₂₄)-aryloxy (e.g. phenoxy), which can optionally carry one or more radicals, such as (C₁-C₃₀)-arylalkyl (e.g. styrylphenyl) or (C₁-C₃₀)-alkyl, in which the alkyl groups can be linear or branched (e.g. butyl or dodecyl), or
R¹ is a sorbitan ester radical, a glycerol ester radical, or (C₁-C₃₀)-alkyl-NR⁴, preferably (C₁₀-C₂₀)-alkyl-NR⁴, in which the (C₁-C₂₀)-alkyl group can be linear or branched (e.g. dodecyl, hexadecyl, octadecyl) and in which R⁴ is the same as H or is (C₁-C₁₀)-alkyl (e.g. methyl, ethyl, propyl, butyl),
R² is the same as H or is (C₁-C₆)-alkyl which can be linear or branched (e.g. methyl, ethyl, propyl, butyl, pentyl or hexyl), and
w is an integer from 1 to 100, preferably from 4 to 80, in particular from 6 to 50, AO is an alkylene oxide unit, e.g. (EO)_{X}(PO)_{Y}(BO)_{Z}, in which DO is an ethylene oxide unit, PO is a propylene oxide unit, BO is a butylene oxide unit, x is an integer from 0 to 100, y is an integer from 0 to 100, z is an integer from 0 to 100 and the sum x+y+z is at least 1, and the alkylene oxide unit, e.g. (EO)ₓ(PO)_{y}(BO)_{z}, is arranged, in randomly mixed or blockwise fashion.

Particularly preferred nonionic surfactants (e) are alkylaryl polyalkoxylates, e.g. the ethoxylates, propoxylates and/or butoxylates, arylalkylaryl polyalkoxylates, such as tristyrylphenyl polyalkoxylates (e.g. Soprophor® series from Rhodia) and alkylphenyl polyalkoxylates, such as tributylphenyl polyalkoxlates (e.g. Sapogenat® series from Clariant), alkylene oxide block copolymers, such as ethylene oxide (EO)/propylene oxide (PO) block copolymers (e.g. Emulsogen® 3510, Emulsogen® V 1816, Genapol® PF 10, Genapol® PF 20, Genapol® PF 40 from Clariant, Berol® 992 from Akzo Nobel) or ethylene oxide (EO)/butylene oxide (BO) block copolymers (e.g. Pluronic® series from BASF), polyalkylene oxides, such as polyethylene oxides, polypropylene oxides or polybutylene oxides, which can be substituted on one of the two terminal oxygen atoms with (C₁-C₂₂)-hydrocarbon radicals, preferably (C₁₀-C₂₂)-hydrocarbon radicals, such as straight-chain or branched (C₁₀-C₂₂)-alkyl radicals (e.g. decyl, dodecyl, tetradecyl, hexadecyl), e.g. polyglycol ethers which can be substituted with isotridecyl (e.g. Genapol® X-060, Genapol® X-080, Genapol® X-150 and others from the Genapol® series from Clariant), alkoxylated, such as ethoxylated, oils, such as vegetable oils, e.g. alkoxylated, such as ethoxylated, castor oil (Emulsogen® series from Clariant), epoxidized soybean oil (e.g. Edenol® D-81, synonym Agnique® ESO 81 G from Cognis), alkoxylated, such as ethoxylated, (C10-C22)-fatty amines (e.g. Genamin® series, e.g. Genamin® S080 from Clariant).

Insofar as carbon-comprising radicals, such as alkyl, alkoxy, haloalkyl, haloalkoxy, alkylamino and alkylthio, and also the corresponding unsaturated and/or substituted radicals, are mentioned in this description, these can in each case be straight-chain or branched in the carbon backbone. Unless specifically indicated, these radicals generally exhibit from 1 to 30 carbon atoms, preference being given to the lower carbon backbones, e.g. with from 1 to 6 carbon atoms or, for unsaturated groups, with from 2 to 6 carbon atoms. Alkyl radicals, also in the compound meanings, such as alkoxy, haloalkyl, and the like, are, e.g., methyl, ethyl, n-propyl, isopropyl, n-butyl, isobutyl, t-butyl, sec-butyl, pentyls, hexyls, such as n-hexyl, isohexyl and 1,3-dimethylbutyl, heptyls, such as n-heptyl, 1-methylhexyl and 1,4-dimethylpentyl; alkenyl and alkynyl radicals have the meaning of the possible unsaturated radicals corresponding to the alkyl radicals; alkenyl is, e.g., allyl, 1-methylprop-2-en-1-yl, 2-methyl-prop-2-en-1-yl, but-2-en-1-yl, but-3-en-1-yl, 1-methyl-but-3-en-1-yl and 1-methyl-but-2-en-1-yl; alkynyl is, e.g., propargyl, but-2-yn-1-yl, but-3-yn-1-yl, 1-methyl-but-3-yn-1-yl.

Alkenyl in the form (C₃-C₄)-alkenyl, (C₃-C₅)-alkenyl, (C₃-C₆)-alkenyl, (C₃-C₈)-alkenyl or (C₃-C₁₂)-alkenyl is preferably an alkylene radical with from 3 to 4, from 3 to 5, from 3 to 6, from 3 to 8 or from 3 to 12 carbon atoms in which the double bond does not lie on the carbon atom which is bonded to the remaining molecular portion of the compound (“yl” position). This is correspondingly valid for (C₃-C₄)-alkynyl and the like, (C₃-C₄)-alkenyloxy and the like, and (C₃-C₄)-alkynyloxy and the like.

A hydrocarbon radical is a straight-chain, branched or cyclic and saturated or unsaturated aliphatic or aromatic hydrocarbon radical, e.g. alkyl, alkenyl, alkynyl, cycloalkyl, cycloalkenyl or aryl.

A hydrocarbon radical preferably exhibits from 1 to 40 carbon atoms, preferably from 1 to 30 carbon atoms; a hydrocarbon radical is particularly preferably alkyl, alkenyl or alkynyl with up to 12 carbon atoms or cycloalkyl with 3, 4, 5, 6 or 7 ring atoms or phenyl.

Aryl is a mono-, bi- or polycyclic aromatic system, for example phenyl, naphthyl, tetrahydronaphthyl, indenyl, indanyl, pentalenyl, fluorenyl and the like, preferably phenyl.

A heterocyclic radical or ring (heterocyclyl) can be saturated, unsaturated or heteroaromatic and unsubstituted or substituted; it preferably comprises one or more heteroatoms in the ring, preferably from the group consisting of N, O and S; it is preferably an aliphatic heterocyclyl radical with from 3 to 7 ring atoms or a heteroaromatic radical with 5 or 6 ring atoms and comprises 1, 2 or 3 heteroatoms. The heterocyclic radical can, e.g., be a heteroaromatic radical or ring (heteroaryl), such as, e.g., a mono-, bi- or polycyclic aromatic system, in which at least 1 ring comprises one or more heteroatoms, for example pyridyl, pyrimidinyl, pyridazinyl, pyrazinyl, triazinyl, thienyl, thiazolyl, oxazolyl, furyl, pyrrolyl, pyrazolyl and imidazolyl, or is a partially or completely hydrogenated radical, such as oxiranyl, oxetanyl, pyrrolidyl, piperidyl, piperazinyl, dioxolanyl, morpholinyl, tetrahydrofuryl. Possible substituents for a substituted heterocyclic radical are the substituents mentioned further below, additionally also oxo. The oxo group can also occur on the ring heteroatoms, which can exist in different oxidation states, e.g. with N and S.

Halogen is, for example, fluorine, chlorine, bromine or iodine. Haloalkyl, haloalkenyl and haloalkynyl are alkyl, alkenyl or alkynyl partially or completely substituted by halogen, preferably by fluorine, chlorine and/or bromine, in particular by fluorine or chlorine, e.g. CF₃, CHF₂, CH₂F, CF₃CF₂, CH₂FCHCl, CCl₃, CHCl₂, CH₂CH₂Cl; haloalkoxy is, e.g., OCF₃, OCHF₂, OCH₂F, CF₃CF₂O, OCH₂CF₃ and OCH₂CH₂Cl; This is correspondingly valid for haloalkenyl and other radicals substituted by halogen.

Hydrocarbon radicals, e.g. alkyl, alkenyl, alkynyl, aryl, phenyl and benzyl, or heterocyclyl or heteroaryl, can be substituted, the substituents being, for example, one or more, preferably 1, 2 or 3, radicals from the group consisting of halogen, alkoxy, haloalkoxy, alkylthio, hydroxyl, amino, nitro, carboxyl, cyano, azido, alkoxycarbonyl, alkylcarbonyl, formyl, carbamoyl, mono- and dialkylaminocarbonyl, substituted amino, such as acylamino, mono- and dialkylamino, and alkylsulfinyl, haloalkylsulfinyl, alkylsulfonyl, haloalkylsulfonyl and, in the case of cyclic radicals, also alkyl and haloalkyl, and also unsaturated aliphatic radicals corresponding to the abovementioned saturated hydrocarbon-comprising radicals, such as alkenyl, alkynyl, alkenyloxy, alkynyloxy, and the like. For radicals with carbon atoms, those with from 1 to 4 carbon atoms, in particular 1 or 2 carbon atoms, are preferred.

Preference is generally given to substituents from the group consisting of halogen, e.g. fluorine and chlorine, (C₁-C₄)-alkyl, preferably methyl or ethyl, (C₁-C₄)-haloalkyl, preferably trifluoromethyl, (C₁-C₄)-alkoxy, preferably methoxy or ethoxy, (C₁-C₄)-haloalkoxy, nitro and cyano. Particular preference is given in this connection to the substituents methyl, methoxy and chlorine.

Phenyl which is, if appropriate, substituted is preferably phenyl which is unsubstituted or substituted one or more times, preferably up to three times, by identical or different radicals from the group consisting of halogen, (C₁-C₄)-alkyl, (C₁-C₄)-alkoxy, (C₁-C₄)-haloalkyl, (C₁-C₄)-haloalkoxy and nitro, e.g. o-, m- and p-tolyl, dimethylphenyls, 2-, 3- and 4-chlorophenyl, 2-, 3- and 4-trifluorophenyl and 2-, 3- and 4-trichlorophenyl, 2,4-, 3,5-, 2,5- and 2,3-dichlorophenyl, o-, m- and p-methoxyphenyl.

An acyl radical is the radical of an organic acid which results formally by splitting off an OH group from the organic acid, e.g. the radical of a carboxylic acid and radicals of acids derived therefrom, such as thiocarboxylic acid, iminocarboxylic acids, if appropriate N-substituted, or the radicals of carbonic acid monoesters, carbamates, if appropriate N-substituted, sulfonic acids, sulfinic acids, phosphonic acids, phosphinic acids.

An acyl radical is preferably formyl or aliphatic acyl from the group consisting of CO—R^{x}, CS—R^{x}, CO—OR^{x}, CS—OR^{x}, CS—SR^{x}, SOR^{Y} and SO₂R^{Y}, R^{x} and R^{Y} being in each case a (C₁-C₃₀)-hydrocarbon radical which is unsubstituted or substituted, or aminocarbonyl or aminosulfonyl, the two last-mentioned radicals being unsubstituted, N-monosubstituted or N,N-disubstituted.

Acyl is, for example, formyl, haloalkylcarbonyl, alkylcarbonyl, such as (C₁-C₄)-alkylcarbonyl, phenylcarbonyl, it being possible for the phenyl ring to be substituted, e.g. as indicated above for phenyl, or alkyloxycarbonyl, phenyloxycarbonyl, benzyloxycarbonyl, alkylsulfonyl, alkylsulfinyl, N-alkyl-1-iminoalkyl and other radicals of organic acids.

Formula (I), (II), (III) and the other compounds mentioned in this description also comprise stereoisomers and the mixtures thereof. Such compounds comprise one or more asymmetric carbon atoms or also double bonds which are not separately indicated in the general formula. The possible stereoisomers defined by their specific spatial form, such as enantiomers, diastereomers, Z- and E-isomers, are all included under the respective formulae and can be obtained according to conventional methods from mixtures of the stereoisomers or can also be prepared by stereoselective reactions in combination with the use of stereochemically pure starting materials.

The microemulsion concentrates according to the invention can be prepared by standard processes, e.g. mixing by dissolving or emulsifying the individual components, preferably at ambient temperature. If additional auxiliaries and additives are present, these are likewise preferably charged at ambient temperature. In this connection, the individual components are generally added in any sequence.

The preparation processes are known in principle and are described, for example, in Winnacker-Küchler, “Chemische Technologie” [Chemical Technology], Volume 7, C. Hanser Verlag, Munich, 4^{th} Ed., 1986; Wade van Valkenburg, “Pesticide Formulations”, Marcel Dekker, N.Y., 1973; K. Martens, “Spray Drying” Handbook, 3^{rd} Ed., 1979, G. Goodwin Ltd., London; H. Mollet, A. Grubenmann, “Formulierungstechnik” [Formulation Technology], Wiley-VCH, Weinheim, 2000.

The formulation auxiliaries, such as inert materials, and additional additives are likewise known and are described, for example, in: “Solvents Guide”; 2^{nd} Ed., Interscience, N.Y. 1963; McCutcheon's “Detergents and Emulsifiers Annual”, MC Publ. Corp., Ridgewood N.J.; Sisley and Wood, “Encyclopedia of Surface Active Agents”, Chem. Publ. Co. Inc., N.Y., 1964; Schönfeldt, “Grenzflächenaktive Äthylenoxidaddukte” [Surface-active Ethylene Oxide Adducts], Wiss. Verlagsgesell., Stuttgart, 1976; Winnacker-Küchler, “Chemische Technologie” [Chemical Technology], Volume 7, C. Hanser Verlag, Munich, 4^{th} Ed., 1986.

Based on these formulations, combinations with agrochemical active substances, such as fungicides, insecticides and/or growth regulators, other than components (a) and (b) can also be prepared, e.g. in the form of a ready-for-use formulation or as tank mix.

The microemulsion concentrates according to the invention can be diluted with water to give microemulsions, which are likewise a subject matter of the present invention. In this connection, the microemulsion concentrate/water ratio by weight can, for example, be from 1:0.00001 to 0.1:1000, preferably from 1:0.0001 to 0.1:100, which results in concentrated microemulsions which as such are stable on storage. For application purposes, these can be further diluted with water to give spray slurries, which generally exist in the form of emulsions, such as microemulsions, aqueous solutions, suspensions or suspoemulsions.

The components (a), (b), (c), (d), (e) and optionally (f) of the microemulsion concentrates and microemulsions according to the invention can be present together in a ready-for-use formulation which can then be applied in a conventional way, e.g. in the form of a spray slurry.

The microemulsion concentrates according to the invention, inclusive of the spray slurry obtainable therefrom (subsequently described together as agrochemical compositions according to the invention), can comprise various formulation auxiliaries (component f) as additional component, in addition to the components (a), (b), (c), (d) and (e), e.g. conventional auxiliaries and additives, such as drift retardants, substances for influencing the humidity (humectants), fertilizers, such as ammonium sulfate, urea or multicomponent fertilizers, e.g. based on phosphorus, potassium and nitrogen, such as NPK fertilizers, or commercial surfactants other than components (d) and (e), such as betaine or polymer surfactants, stabilizers, such as pH stabilizers, biocides, UV stabilizers, antifoaming agents, synthetic or natural polymers. These agrochemical compositions and the preparation and use thereof are likewise novel and a subject-matter of this invention.

Preferred examples of conventional auxiliaries and additives (f) are
wetting agents, such as Genapol® LRO (0-35% by weight), dispersants, such as Tamol® (0-15% by weight) or additional surfactants (e.g. cationic or polymer surfactants) (0-30% by weight);
inorganic salts, such as NaCl, Na₂SO₄, MgCl₂ (0-50% by weight), (oligo-; poly-)phosphates; carbonates, such as potassium carbonate;
fertilizers such as ammonium sulfate, ammonium nitrate, urea, phosphorus- and potassium-comprising components, if appropriate additional trace elements (0-60% by weight);
antifoaming agents, such as Fluowet® PP (0-2% by weight) or from the Rhodorsil® series (e.g. Rhodorsil® 481);
binders, such as suitable natural or synthetic substances, such as polyamino acids, polyvinyl alcohols, polyvinylpyrrolidone, polyacrylic acid derivatives (0-15% by weight);
crystallization inhibitors (0-8% by weight).

The agrochemical compositions according to the invention can, e.g., be used by application to the harmful organisms or the sites on which they occur, e.g. by spraying. The agrochemical compositions according to the invention are generally applied in the form of a spray slurry comprising the components (a), (b), (c), (d) and (e) in effective amounts and, if appropriate, conventional auxiliaries and additives (f), e.g. for the formulation or application. The spray slurry is generally prepared based on water, to which conventional auxiliaries and additives (f), e.g. oils, such as vegetable oils, or high boiling point hydrocarbons, such as kerosene or paraffin, can be added.

For the application, the concentration of active substance (component a) is generally from 10⁻⁶ to 10% by weight, preferably from 10⁻⁶ to 4% by weight, in the composition applied, e.g. the spray slurry, with an amount expended of 1 to 5000 l/ha, preferably of 50 to 1000 l/ha.

For use, concentrated formulations present in commercial form are, if appropriate, diluted in the usual way, e.g. using water. It can be advantageous to add, to the spray slurries, additional amounts of components (c), (d) and (e) and/or other auxiliaries and additives (f) conventional for use, in particular self-emulsifying oils or paraffin oils. Additional components (a) or other agrochemical active substances other than components (a) can also be added.

Preferred mixtures are compounds which are effective as ACCase inhibitors or as p hydroxyphenyl pyruvate dioxygenase (HPPD) inhibitors with compounds which are effective as safeners, as explained above, which can then be used as ready-for-use formulation or as tank mix for the preparation of spray slurries.

The amount of the agrochemical active substances (component a) which has to be expended can vary with the external conditions, such as temperature, humidity, type of herbicide used. It can fluctuate within wide limits, e.g. between 0.001 and 10 kg/ha or more of active substance; preferably, it lies between 0.005 and 5 kg/ha.

If the agrochemical compositions according to the invention are preferably herbicidal compositions, these exhibit an outstanding herbicidal activity against a broad spectrum of economically important harmful monocotyledonous and dicotyledonous plants. Even perennial weeds which sprout from rhizomes, rootstocks or other perennial organs and which are difficult to combat are successfully included. In this connection, the compositions can be applied, e.g., in the presowing, preemergence or postemergence method. Specifically, mention may be made, by way of example, of some representatives of the mono- and dicotyledonous weed flora which can be controlled by the herbicidal compositions according to the invention, without the designation resulting in a limitation to certain species.

In the case of the monocotyledonous weed species, Apera spica-venti, Avena spp., Alopecurus spp., Brachiaria spp., Digitaria spp., Leptochloa spp., Lolium spp., Echinochloa spp., Panicum spp., Phalaris spp., Poa spp., Setaria spp. and also Bromus spp., such as Bromus catharticus, Bromus secalinus, Bromus erectus, Bromus tectorum and Bromus japonicus, and Cyperus species from the group of the annuals and, in the case of the perennial species, Agropyron, Cynodon, Imperata and also Sorghum and even perennial Cyperus species, e.g., are successfully included.

With dicotyledonous weed species, the spectrum of activity applies to species such as, e.g., Abutilon spp., Amaranthus spp., Chenopodium spp., Chrysanthemum spp., Galium spp., such as Galium aparine, Ipomoea spp., Kochia spp., Lamium spp., Matricaria spp., Pharbitis spp., Polygonum spp., Sida spp., Sinapis spp., Solanum spp., Stellaria spp., Veronica spp. and Viola spp., Xanthium spp., in the case of the annuals, and Convolvulus, Cirsium, Rumex and Artemisia with the perennial weeds.

Harmful plants occurring under the specific cultivation conditions in rice, such as, e.g., Echinochloa, Sagittaria, Alisma, Eleocharis, Scirpus and Cyperus, are likewise combated in an outstanding fashion by the compositions according to the invention.

If the herbicidal compositions according to the invention are applied to the soil surface before germination, then either the emergence of the weed seedlings is completely prevented or the weeds grow until they have reached the cotyledon stage but then their growth ceases and finally, after 3 to 4 weeks have elapsed, they completely die.

On application of the herbicidal compositions according to the invention to the green parts of the plants in the postemergence method, a drastic halt in growth likewise occurs very quickly after the treatment and the weed plants stay in the growth stage present at the time of application or completely die after a certain time, so that in this way competition by weeds, which is harmful for the crop plants, is eliminated very early and with lasting effect.

The herbicidal compositions according to the invention are distinguished by a rapidly commencing and longlasting herbicidal action. The resistance to rain of the active substances in the combinations according to the invention is generally good. A particular advantage is crucially that the dosages of herbicidal compounds which are used in the herbicidal compositions and which are effective can be adjusted to such a low value that their soil action is optimally low. Accordingly, not only is their use finally possible in sensitive crops but groundwater contamination is virtually avoided. A substantial reduction in the amount of the active substances which has to be expended is made possible by the active substance combination according to the invention.

The properties and advantages mentioned are of use in the practical combating of weeds in order to keep agricultural crops free from undesirable competing plants and accordingly to safeguard and/or to increase the yields in terms of quality and quantity. The technical standard is, with regard to the properties described, clearly exceeded by these new compositions.

Although the herbicidal compositions according to the invention exhibit an outstanding herbicidal activity with regard to mono- and dicotyledonous weeds, crop plants of economically important crops, e.g. dicotyledonous crops, such as soya, cotton, rape, sugar beet, or gramineous crops, such as wheat, barley, rye, oats, millet, rice or corn, are only insignificantly damaged or completely undamaged. The present compounds are, for these reasons, very well suited to the selective combating of undesirable plant growth in agriculturally useful plants or in ornamental plants.

In addition, the herbicidal compositions according to the invention exhibit outstanding growth-regulatory properties in crop plants. They intervene in a regulatory manner in the plants' metabolism and can accordingly be used for the selective influencing of plant contents and for making it easier to harvest, such as, e.g., by controlling desiccation and stunted growth. Furthermore, they are also suitable for the general control and inhibition of undesirable vegetative growth, without in this connection killing the plants. Inhibition of vegetative growth plays a major role in many mono- and dicotyledonous crops since lodging can be reduced or completely prevented through this.

Because of their herbicidal and plant-growth-regulatory properties, the herbicidal compositions according to the invention can also be used for combating harmful plants in crops of known genetically modified plants or genetically modified plants still to be developed. The transgenic plants are generally distinguished by particular advantageous properties, for example by resistance to certain pesticides, mainly certain herbicides, resistance to plant diseases or causative agents of plant diseases, such as certain insects or microorganisms, such as fungi, bacteria or viruses. Other particular properties relate, e.g., to the harvested crops with regard to amount, quality, storability, composition and special ingredients. Thus, transgenic plants with increased starch content or modified quality of the starch or those with a different fatty acid composition of the harvested crops are known.

The herbicidal compositions according to the invention can also be used in economically important transgenic crops of useful and ornamental plants, e.g. of gramineous crops, such as wheat, barley, rye, oats, millet, rice and corn, or also crops of sugar beet, cotton, soya, rape, potato, tomato, peas and other kinds of vegetable. Preferably, the compositions according to the invention can be used as herbicides in crops of useful plants which are resistant to the phytotoxic effects of the herbicides or which have been made resistant by genetic engineering.

When the herbicidal compositions according to the invention are used in transgenic crops, effects often occur, in addition to the effects with regard to harmful plants to be observed in other crops, which are specific for the application in the respective transgenic crop, for example a modified or specially broadened weed spectrum which can be combated, modified amounts to be expended which can be used for the application, preferably good ability to be combined with the herbicides to which the transgenic crop is resistant, and influencing of growth and yield of the transgenic crop plants.

Another subject matter of the present invention is furthermore a process for combating undesirable plant growth, preferably in crop plants, such as cereals (e.g., wheat, barley, rye, oats, rice, corn, millet), sugar beet, sugar cane, rape, cotton and soya, particularly preferably in monocotyledonous crops, such as cereals, e.g. wheat, barley, rye, oats, hybrids thereof, such as triticale, rice, corn and millet, the herbicidal composition according to the invention being applied to the harmful plants, plant parts, plant seeds or the area on which the plants are growing, e.g. the area under cultivation, e.g. in preemergence, postemergence or in pre- and postemergence, preferably in preemergence.

The crop plants can also be modified by genetic engineering or obtained by mutation selection and are preferably tolerant to acetolactate synthase (ALS) inhibitors.

A subject matter of the invention is also the use of the herbicidal compositions according to the invention for combating harmful plants, preferably in crop plants. A preferred use relates to the use of herbicidal compositions comprising synergistic amounts of components (a), (b), (c), (d), (e) and, if appropriate (f).

The herbicidal compositions according to the invention can also be used nonselectively for combating undesirable plant growth, e.g. in plantation crops, on roadsides, yards, industrial plants or railroad installations.

The agrochemical compositions according to the invention, in particular herbicidal compositions, can, if appropriate, exist as mixed formulations with additional agrochemical active substances (e.g. additional herbicides and safeners, insecticides, fungicides, growth regulators) and conventional auxiliaries and additives (f) which are then used in the conventional way diluted with water, or prepared as “tank mixes” by joint diluting of the separately formulated or partially separately formulated components with water.

Because of the relatively low amount of the herbicidal compositions according to the invention expended, the tolerance thereof is generally very good. In particular, a reduction in the absolute amount expended is achieved by the combinations according to the invention, compared with the individual use of a herbicidal active substance.

Another subject matter of the invention is accordingly a process for the selective combating of harmful plants in crop plants, which comprises applying a herbicidally effective amount of herbicides (a), alone or together with safeners, in combination with the components (c), (d) and (e), to the plants, plant parts, plant seeds or the site or the area on which the plants are growing, e.g. the area under cultivation, if appropriate in combination with component (f), e.g. in pre-emergence, post-emergence or in pre- and post-emergence, preferably in pre-emergence.

In a preferred alternative form of the process, the herbicides (a) are applied in amounts expended in the field of 0.1 to 2000 g of active substance/ha, preferably of 0.5 to 1000 g of active substance/ha. The amounts of the safener (a) which have to be expended in the field can, according to the indication and herbicide used, fluctuate within wide limits and generally range from 0.001 to 1 kg, preferably from 0.005 to 0.2 kg, of active substance/ha.

Furthermore, particular preference is given to the application of the active substances in the form of a coformulation or in the form of tank mixes, the individual components, e.g. in the form of formulations, being mixed together in the tank with water and the spray slurry obtained being applied.

Since the crop plant tolerance of the combinations according to the invention, with simultaneously very great control of harmful plants, is extremely good, these can be regarded as selective. In a preferred alternative form of the process, herbicidal compositions with the active substance combinations according to the invention are accordingly used for the selective combating of undesirable plants.

The herbicidal compositions according to the invention can be applied in a conventional way, for example, with water as carrier, in spray slurry amounts from approximately 5 to 4000 liters/ha. Use of the compositions in “low volume” and “ultralow volume” (ULV) processes is likewise possible.

In addition, in order to round off the properties, one, two or more agrochemical active substances other than component (a) from other fields (e.g. insecticides, fungicides, growth regulators) may additionally be present in the herbicidal compositions of the invention, generally in secondary amounts.

Accordingly, numerous possibilities ensue for combining several agrochemical active substances with one another and for using them together for combating harmful organisms, such as harmful plants, in crop plants, without departing from the spirit of the invention.

The microemulsion concentrates and microemulsions according to the invention show an improved chemical and physical stability and also an advantageous physical application behavior. The agrochemical active substances of the component (a), and also, if appropriate, additional agrochemical active substances added, remain uniformly distributed in the spray tank during the application, making possible uniform application to the crop or area under cultivation. In addition, mixtures (tank mixes), such as aqueous solutions, suspensions, emulsions or suspoemulsions, formed in the spray tank are stable.

The agrochemical compositions according to the invention exhibit, an excellent biological action and are preferably synergistic. These effects allow, inter alia, a reduction in the amount expended, the control of a broader spectrum of harmful organisms, the elimination of areas where action was absent, a faster and safer action, a longer lasting action, complete control of the harmful organisms with only one or a few applications, and an extension of the period of use.

The following implementation examples explain the invention but do not have any limiting nature.

### EXAMPLES

### 1. Preparation and Storage of the Formulations

The solvents were introduced and, with stirring, first the agrochemical active substances and then the surfactants and conventional auxiliaries and additives were added. The microemulsion concentrates thus obtained were stored over a period of 3 months, inter alia, at −10, 0, 25, 40 and 50 degrees Celsius and were chemically and physically stable during the entire length of time.

### 2. Compositions

The amounts of the compound components of the individual formulations are indicated in the following table I in % by weight.

TABLE I
Formulation examples Nos. 1-10

| | | Examples | | | | | | | | | |
|---|---|---|---|---|---|---|---|---|---|---|---|
| Component | | 1 | 2 | 3 | 4 | 5 | 6*** | 7*** | 8 | 9 | 10 |
| (a) | Metamitron | | | | | | | | | 2.50 | 2.50 |
| (a) | Diclofop-methyl | | | | | | | | 24.00 | | |
| (a) | Fenoxaprop-P-ethyl | 9.30 | 9.30 | 9.30 | 9.30 | 9.30 | 6.63 | 6.63 | 2.00 | | |
| (a) | Mefenpyr-diethyl | 4.60 | 4.60 | 4.60 | 4.60 | 4.60 | | | 3.80 | | |
| (b) | Benzyl alcohol | 10.00 | | | | | 5.00 | 10.00 | | 5.00 | 5.00 |
| (b) | n-Decanol | | 10.00 | | | | | | | | |
| (b) | n-Hexanol | | | 10.00 | | | | | | | |
| (b) | n-Octanol | | | | 10.00 | | | | | | |
| (b) | n-(1-)Heptanol | | | | | 10.00 | | | 10.00 | | |
| (c) | Edenor ® MESU | 15.00 | 15.00 | 15.00 | 15.00 | 15.00 | | | 18.50 | | |
| (c) | N-Methylpyrrolidone | | | | | | 15.00 | 10.00 | | | |
| (c) | Solvesso ® 200 | | | | | | 23.35 | 32.49 | | | |
| (c) | Solvesso ® 200 ND | 16.60 | 16.60 | 16.60 | 16.60 | 16.60 | | | | 38.70 | 38.70 |
| (c) | Triethyl phosphate | | | | | | | | | 5.00 | 5.00 |
| (d) | Phenylsulfonate ® | | | | | | 10.00 | | | | |
| | Ca 100 | | | | | | | | | | |
| (d) | Phenylsulfonate ® | | | | | | | 8.00 | | 4.00 | 4.00 |
| | Ca 70 | | | | | | | | | | |
| (d) | Triton ® GR7 ME | 7.00 | 7.00 | 7.00 | 7.00 | 7.00 | | | 7.00 | | |
| (e) | Emulsogen 3510 | | | | | | 4.00 | 3.50 | | | |
| (e) | Emulsogen ® V 1816 | 12.00 | 12.00 | 12.00 | 12.00 | 12.00 | | | 12.00 | 12.00 | 12.00 |
| (e) | Genapol ® X-060 | | | | | | 12.02 | | | | |
| (e) | Genapol ® X-080 | 19.50 | 19.50 | 19.50 | 19.50 | 19.50 | | 15.38 | 19.20 | 23.80 | 23.80 |
| (e) | Genapol ® PF 10 | | | | | | 2.00 | | | | |
| (e) | Genapol ® PF 20 | | | | | | | | 2.00 | | 6.00 |
| (e) | Genapol ® PF 40 | 4.00 | 4.00 | 4.00 | 4.00 | 4.00 | | 2.00 | | 6.00 | |
| (e) | Berol ® 992 | | | | | | | 10.00 | | | |
| (e) | Crillet ® 45 | | | | | | 14.00 | | | | |
| (e) | Edenol ® D-81 | 2.00 | 2.00 | 2.00 | 2.00 | 2.00 | 2.00 | 2.00 | 1.00 | 3.00 | 3.00 |
| (e) | Etocas ® 29 | | | | | | 6.00 | | | | |
| (e) | Genamin ® S080 | | | | | | | | 0.50 | | |

| | | | | | | | | | | |
|---|---|---|---|---|---|---|---|---|---|---|
| Total amount: | 100 | 100 | 100 | 100 | 100 | 100 | 100 | 100 | 100 | 100 |

Formulation examples Nos. 11-20

| | | Examples | | | | | | | | | |
|---|---|---|---|---|---|---|---|---|---|---|---|
| Component | | 11 | 12 | 13 | 14 | 15 | 16 | 17 | 18 | 19 | 20 |
| (a) | Phenmedipham | 7.30 | 7.30 | 7.30 | | | | | 7.30 | | 7.30 |
| (a) | Desmedipham | | | | 2.41 | | 2.50 | 2.50 | 2.41 | 2.41 | |
| (a) | Ethofumesate | | | | | 14.75 | | | | 14.75 | 14.75 |
| (b) | Benzyl alcohol | 5.00 | 5.00 | 5.00 | 5.00 | 5.00 | 5.00 | 5.00 | 5.00 | 5.00 | 5.00 |
| (c) | Solvesso ® 200 ND | 41.18 | 37.18 | 37.18 | 46.07 | 33.73 | 38.70 | 38.70 | 38.77 | 31.32 | 26.43 |
| (d) | Phenylsulfonate ® | 4.00 | 10.00 | 10.00 | 4.00 | 4.00 | 4.00 | 4.00 | 4.00 | 4.00 | 4.00 |
| | Ca 70 | | | | | | | | | | |
| (e) | Emulsogen ® V 1816 | 10.00 | 10.00 | 10.00 | 10.00 | 10.00 | 12.00 | 12.00 | 10.00 | 10.00 | 10.00 |
| (e) | Genapol ® X-080 | 18.52 | 18.52 | 18.52 | 18.52 | 18.52 | 23.80 | 23.80 | 18.52 | 18.52 | 18.52 |
| (e) | Genapol ® PF 20 | | | 6.00 | | | | 6.00 | | | |
| (e) | Genapol ® PF 40 | 6.00 | 6.00 | | 6.00 | 6.00 | 6.00 | | 6.00 | 6.00 | 6.00 |
| (e) | Edenol ® D-81 | 3.00 | 1.00 | 1.00 | 3.00 | 3.00 | 3.00 | 3.00 | 3.00 | 3.00 | 3.00 |
| (c) | Triethyl phosphate | 5.00 | 5.00 | 5.00 | 5.00 | 5.00 | 5.00 | 5.00 | 5.00 | 5.00 | 5.00 |

| | | | | | | | | | | |
|---|---|---|---|---|---|---|---|---|---|---|
| Total amount: | 100 | 100 | 100 | 100 | 100 | 100 | 100 | 100 | 100 | 100 |

Formulation example No. 21

| | | Example |
|---|---|---|
| Component | | 21 |
| (a) | Lactofen | 10.00 |
| (b) | Benzyl alcohol | 15.00 |
| (c) | Solvesso ® 200 | 20.00 |
| (c) | Xylene | 10.00 |
| (d) | Phenylsulfonate ® | 7.00 |
| | Ca 70 | |
| (e) | Emulsogen ® V 1816 | 10.00 |
| (e) | Genapol ® PF 40 | 6.00 |
| (e) | Arkopal ® N100 | 20.00 |
| (e) | Edenol ® D-81 | 2.00 |

| | |
|---|---|
| Total amount: | 100 |

All figures in % by weight;
***Examples for comparative tests

The commercial products used are explained below:

| | |
|---|---|
| Phenmedipham (Bayer CropScience): | Herbicide |
| Desmedipham (Bayer CropScience): | Herbicide |
| Ethofumesate (Bayer CropScience): | Herbicide |
| Metamitron (Bayer CropScience): | Herbicide |
| Lactofen (Bayer CropScience): | Herbicide |
| Fenoxaprop-P-ethyl (Bayer | Herbicide |
| CropScience): | |
| Mefenpyr-diethyl (Bayer CropScience): | Safener |
| Benzyl alcohol (Merck): | Aromatic alcohol with at least 5 |
| | carbon atoms |
| Berol ® 992 (Akzo Nobel): | Alcohol ethoxylate propoxylate |
| Edenol ® D 81 | Epoxidized soybean oil |
| (synonym Agnique ® ESO 81 G; | |
| Cognis): | |
| Edenor ® MESU (Cognis): | Rapeseed oil methyl ester |
| Emulsogen ® 3510 (Clariant): | EO/PO block copolymer |
| Emulsogen ® V 1816 (Clariant): | EO/PO block copolymer |
| Genapol ® X-060 (Clariant): | Isotridecyl alcohol with 6 |
| | ethylene oxide units |
| Genapol ® X-080 (Clariant): | Isotridecyl alcohol with 8 |
| | ethylene oxide units |
| Genapol ® PF 10 (Clariant): | EO/PO/EO block copolymer |
| Genapol ® PF 20 (Clariant): | EO/PO/EO block copolymer |
| Genapol ® PF 40 (Clariant): | EO/PO/EO block copolymer |
| Phenylsulfonate ® Ca 70 (Clariant): | Calcium |
| | dodecylbenzenesulfonate |
| Phenylsulfonate ® Ca 100 | Calcium |
| (synonym Calsogen ® | dodecylbenzenesulfonate |
| AR 100 ND, Clariant): | |
| Solvesso ® 200 (Exxon): | Mixture of aromatic compounds |
| Solvesso ® 200 ND (Exxon): | Mixture of aromatic compounds |
| | (Naphthalene content <1% by |
| | weight) |
| Triton ® GR 7 ME (Union Carbide): | Di(2-ethylhexyl) sodium |
| | sulfosuccinate |
| Arkopal ® N100 (Clariant): | Nonylphenol polyglycol ethers |
| Crillet ® 45 (Croda): | POE-20 sorbitan trioleate |
| Etocas ® 29 (Croda): | Ethoxy(29) castor oil |
| Triethyl phosphate (Merck): | Triethyl phosphate |
| Xylene (Exxon): | Aromatic hydrocarbon |
| N-Methylpyrrolidone (BASF): | N-Methyl-2-pyrrolidone |
| n-Decanol (Merck): | C₁₀-Alcohol |
| n-Octanol (Merck): | C₈-Alcohol. |
| n-Heptanol (Merck): | C₇-Alcohol |
| n-Hexanol (Merck): | C₆-Alcohol |

### 3. Biological Comparative Test

The microemulsion concentrates according to the invention listed in table I exhibit the desired properties. The action of the microemulsion concentrates according to the invention on weeds is represented in table II, in comparison with a standard formulation at the same concentration of use.

### 3.1 Experimental Procedure—

Procedure as field trial in North America. Weeds and crop plants were sown in plots next to one another and, after emergence, were treated evenly in the transverse strip method with the test participants. Grading was carried out 4 weeks after treatment with the grades: 0 (no weed control)-100 (complete weed control).

### 3.2 Test Results—

TABLE II
Action of the different formulation types

| | | Echinochloa | Leptochloa |
|---|---|---|---|
| | | crus-galli/ | panicea/ |
| Use of the herbicide | Dosage | ECHCG | LEFFI |
| fenoxaprop-P-ethyl | [g of active | [% weed | [% weed |
| as: | substance/ha] | control] | control] |
| Standard formulation *) | 45 | 70 | 83 |
| (state of the art) | | | |
| Microemulsion concentrate | 45 | 90 | 96 |
| (according to the invention, | | | |
| example 6 from table I) | | | |
| Microemulsion concentrate | 45 | 91 | 96 |
| (according to the invention, | | | |
| example 7 from table I) | | | |

*) Composition of “Furore Super EW 69” (manufacturer Bayer CropScience, available commercially).

### 3.3 Discussion of the Results—

As emerges from table II, the microemulsion concentrates according to the invention result in a clearly improved biological action at the same dosage of use as the standard formulation of the state of the art.

1. A microemulsion concentrate, comprising
a) one or more agrochemical active substances, in particular from the group consisting of the fungicides, insecticides, plant growth regulators, herbicides and
safeners,
b) one or more alcoholic solvents with at least 5 carbon atoms,
c) one or more nonalcoholic solvents,
d) one or more anionic surfactants, and
e) one or more nonionic surfactants.

2. The microemulsion concentrate as claimed in claim 1, which comprises, as component (a), one or more herbicidal active substances, alone or together with safeners.

3. The microemulsion concentrate as claimed in claim 1, which comprises, as component (b), one or more solvents from the group consisting of benzyl alcohol, n-hexanol, isohexanol, s-hexanol, n-heptanol, isoheptanol, s-heptanol, n-octanol, isooctanol and s-octanol.

4. The microemulsion concentrate as claimed in claim 1, which comprises, as component (d), one or more anionic surfactants from the group consisting of sulfates, sulfonates, phosphates and phosphonates of hydrocarbons which can be optionally alkoxylated sulfosuccinates, dialkyl sulfosuccinates, alkylarylsulfonates, alkyl ether sulfates, alkyl sulfates, alkylsulfonates, alkyl polyglycol ether phosphates, alkylaryl polyglycol ether phosphates and phosphonates.

5. The microemulsion concentrate as claimed in claim 1, which comprises, as component (e), one or more nonionic surfactants from the group consisting of alkoxylates, alkylaryl polyalkoxylates, alkylene oxide block copolymers, polyalkylene oxides which can be substituted by (C₁₀-C₂₂)-hydrocarbon radicals, alkoxylated oils, alkoxylated (C₁₀-C₂₂)-fatty amines.

6. The microemulsion concentrate as claimed in claim 1, which additionally comprises conventional auxiliaries and additives (component f).

7. A process for the preparation of a microemulsion concentrate as claimed in claim 1, which comprises mixing the components.

8. A process for the preparation of a microemulsion which comprises of adding an aqueous solution to the microemulsion concentration of claim 1.

9. An agrochemical composition in the form of a microemulsion or the spray slurry which can be obtained therefrom, which comprises the microemulsion concentrate of claim 1 and water.

10. The agrochemical composition as claimed in claim 9, which additionally comprises conventional auxiliaries and additives (component f).

11. The agrochemical composition as claimed in claim 9, which comprises, as component (b), one or more solvents from the group consisting of benzyl alcohol, n-hexanol, isohexanol, s-hexanol, n-heptanol, isoheptanol, s-heptanol, n-octanol, isooctanol and s-octanol.

12. An agrochemical composition, which is obtained by diluting a microemulsion concentrate as claimed in claim 1 with water.

13. A process for the preparation of an agrochemical composition as claimed in claim 9, which comprises mixing the components.

14. A process for combating harmful organisms, which comprises applying an effective amount of an agrochemical composition as claimed in claim 9 to the harmful organisms or the sites on which they occur.

15. A process for combating undesirable plant growth, which comprises applying an effective amount of a herbicidal composition as claimed in claim 9 to the harmful plants, parts of the plants, plant seeds, site or area on which plants are growing.

16. (canceled)

17. The process as claimed in claim 14, wherein the harmful organisms are harmful plants.
